(19) United States
(12) Patent Application Publication
(10) Pub. No.: US 2026/0231174 A1
(43) Pub. Date: Aug. 6, 2026

(54) MULTI-TRANSPORT BLOCK SCHEDULING

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 19/046,814

(22) Filed: Feb. 6, 2025

(51) Int. Cl. H04W 72/232; H04W 72/1273

(52) U.S. Cl. CPC H04W 72/232; H04W 72/1273

(57) ABSTRACT

Methods, systems, and devices for wireless communications are described. A user equipment (UE) may receive control signaling that enables a spatial bundling feature for feedback The UE may receive a downlink control information message that includes a single new data indicator (NDI) field associated with two or more transport blocks based on the spatial bundling feature being active. The single NDI field may indicate whether the two or more transport blocks include data that is the same as or different from previous data conveyed via one or more previous transport blocks. The UE may communicate at least one transport block of the two or more transport blocks according to the downlink control information message and the single new data indicator field.

### FIELD OF TECHNOLOGY

The following relates to wireless communications, including multi-transport block scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that enables a spatial bundling feature for feedback, receiving a downlink control information message that includes a single new data indicator (NDI) field associated with two or more transport blocks based on the spatial bundling feature being active, where the single NDI field indicates whether the two or more transport blocks include data that is the same as or different from previous data conveyed via one or more previous transport blocks, and communicating at least one transport block of the two or more transport blocks according to the downlink control information message and the single NDI field.

A UE for wireless communications is described. The UE may include one or more memories storing processor executable code, and one or more processors coupled with the one or more memories. The one or more processors may individually or collectively be operable to execute the code to cause the UE to receive control signaling that enables a spatial bundling feature for feedback, receive a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and communicate at least one transport block of the two or more transport blocks according to the downlink control information message and the single NDI field.

Another UE for wireless communications is described. The UE may include means for receiving control signaling that enables a spatial bundling feature for feedback, means for receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and means for communicating at least one transport block of the two or more transport blocks according to the downlink control information message and the single NDI field.

A non-transitory computer-readable medium storing code for wireless communications is described. The code may include instructions executable by one or more processors to receive control signaling that enables a spatial bundling feature for feedback, receive a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and communicate at least one transport block of the two or more transport blocks according to the downlink control information message and the single NDI field.

Some examples of the method, UEs, and non-transitory computer-readable medium described herein may further include operations, features, means, or instructions for transmitting a single feedback message that indicates combined feedback for the two or more transport blocks in accordance with the spatial bundling feature being enabled and a value of the single NDI field.

In some examples of the method, UEs, and non-transitory computer-readable medium described herein, receiving the control signaling that enables the spatial bundling feature for feedback may include operations, features, means, or instructions for receiving, via the control signaling, one or more feedback configuration fields that enable the spatial bundling feature for feedback associated with a control channel and that enable feedback associated with a shared channel, where the downlink control information message includes the single NDI field associated with the two or more transport blocks based on the spatial bundling feature being enabled for both of the feedback associated with the control channel and the feedback associated with the shared channel.

Some examples of the method, UEs, and non-transitory computer-readable medium described herein may further include operations, features, means, or instructions for communicating the one or more previous transport blocks that convey the previous data, where the one or more previous transport blocks include a single previous transport block that may be associated with a previous NDI field, and where communicating the two or more transport blocks includes decoding the two or more transport blocks based on the previous NDI field including a different value than the single NDI field associated with the two or more transport blocks.

Some examples of the method, UEs, and non-transitory computer-readable medium described herein may further include operations, features, means, or instructions for communicating the one or more previous transport blocks that convey the previous data, where the one or more previous transport blocks include a single previous transport block that may be associated with a previous NDI field and determining that the two or more transport blocks correspond to new transmissions irrespective of a value of the single NDI field based on the one or more previous transport blocks including the single previous transport block.

Some examples of the method, UEs, and non-transitory computer-readable medium described herein may further include operations, features, means, or instructions for communicating the one or more previous transport blocks that convey the previous data, where the one or more previous transport blocks include a single previous transport block that may be associated with a previous NDI field and determining that the two or more transport blocks correspond to retransmissions of the previous data based on the single NDI field including a same value as the previous NDI field.

In some examples of the method, UEs, and non-transitory computer-readable medium described herein, receiving the downlink control information message may include operations, features, means, or instructions for receiving, via the downlink control information message, a single redundancy version (RV) field that indicates an RV for decoding the two or more transport blocks.

Some examples of the method, UEs, and non-transitory computer-readable medium described herein may further include operations, features, means, or instructions for receiving second control signaling that indicates one or more RV field configurations for one or more downlink control information formats, where the downlink control information message includes the single RV field based on an RV field configuration associated with the downlink control information message.

In some examples of the method, UEs, and non-transitory computer-readable medium described herein, receiving the downlink control information message may include operations, features, means, or instructions for receiving, via the downlink control information message, a single RV field that indicates an RV for decoding the two or more transport blocks and receiving, via the downlink control information message, two or more modulation and coding scheme (MCS) fields that correspond to the two or more transport blocks, where respective values of the two or more MCS fields indicate which one or more transport blocks, of the two or more transport blocks, may be scheduled via the downlink control information message based on the downlink control information message including the single RV field.

In some examples of the method, UEs, and non-transitory computer-readable medium described herein, communicating the at least one transport block may include operations, features, means, or instructions for communicating one transport block of the two or more transport blocks, the one transport block being scheduled by the downlink control information message based on a rule for transport block scheduling in accordance with a value of the two or more MCS fields being associated with a same value for disabling respective transport blocks.

In some examples of the method, UEs, and non-transitory computer-readable medium described herein, communicating the at least one transport block may include operations, features, means, or instructions for communicating two transport blocks scheduled by the downlink control information message based on the respective values of each of the two or more MCS fields including a same value that may be associated with disabling a transport block.

In some examples of the method, UEs, and non-transitory computer-readable medium described herein, receiving the downlink control information message may include operations, features, means, or instructions for receiving, via the downlink control information message, a scheduling quantity field that indicates a quantity of transport blocks, of the two or more transport blocks, that may be scheduled by the downlink control information message, where respective sizes of one or more fields of the downlink control information message, respective values of the one or more fields of the downlink control information message, or any combination thereof may be based on the scheduling quantity field.

In some examples of the method, UEs, and non-transitory computer-readable medium described herein, the scheduling quantity field includes a bitmap and each bit of the bitmap indicates whether a corresponding transport block of the two or more transport blocks may be scheduled by the downlink control information message or may be disabled.

In some examples of the method, UEs, and non-transitory computer-readable medium described herein, receiving the downlink control information message may include operations, features, means, or instructions for receiving, via the downlink control information message, one or more zero-padding bits based on the quantity of transport blocks indicated by the scheduling quantity field.

In some examples of the method, UEs, and non-transitory computer-readable medium described herein, the downlink control information message includes a quantity of bits that may be based on a maximum size from among one or more candidate sizes associated with one or more values of the scheduling quantity field.

In some examples of the method, UEs, and non-transitory computer-readable medium described herein, the single NDI field indicates whether the two or more transport blocks include the data that may be the same as or different from previous data conveyed via the one or more previous transport blocks based on the one or more previous transport blocks and the two or more transport blocks being associated with a same hybrid automatic repeat request identifier.

A method for wireless communications by a network entity is described. The method may include transmitting control signaling that enables a spatial bundling feature for feedback, transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and communicating at least one transport block of the two or more transport blocks according to the downlink control information message and the single NDI field.

A network entity for wireless communications is described. The network entity may include one or more memories storing processor executable code, and one or more processors coupled with the one or more memories. The one or more processors may individually or collectively be operable to execute the code to cause the network entity to transmit control signaling that enables a spatial bundling feature for feedback, transmit a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and communicate at least one transport block of the two or more transport blocks according to the downlink control information message and the single NDI field.

Another network entity for wireless communications is described. The network entity may include means for transmitting control signaling that enables a spatial bundling feature for feedback, means for transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and means for communicating at least one transport block of the two or more transport blocks according to the downlink control information message and the single NDI field.

A non-transitory computer-readable medium storing code for wireless communications is described. The code may include instructions executable by one or more processors to transmit control signaling that enables a spatial bundling feature for feedback, transmit a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks, and communicate at least one transport block of the two or more transport blocks according to the downlink control information message and the single NDI field.

Some examples of the method, network entities, and non-transitory computer-readable medium described herein may further include operations, features, means, or instructions for transmitting a single feedback message that indicates combined feedback for the two or more transport blocks in accordance with the spatial bundling feature being enabled and a value of the single NDI field.

In some examples of the method, network entities, and non-transitory computer-readable medium described herein, transmitting the control signaling that enables the spatial bundling feature for feedback may include operations, features, means, or instructions for transmitting, via the control signaling, one or more feedback configuration fields that enable the spatial bundling feature for feedback associated with a control channel and that enable feedback associated with a shared channel, where the downlink control information message includes the single NDI field associated with the two or more transport blocks based on the spatial bundling feature being enabled for both of the feedback associated with the control channel and the feedback associated with the shared channel.

In some examples of the method, network entities, and non-transitory computer-readable medium described herein, transmitting the downlink control information message may include operations, features, means, or instructions for transmitting, via the downlink control information message, a single RV field that indicates an RV for decoding the two or more transport blocks.

Some examples of the method, network entities, and non-transitory computer-readable medium described herein may further include operations, features, means, or instructions for transmitting second control signaling that indicates one or more RV field configurations for one or more downlink control information formats, where the downlink control information message includes the single RV field based on an RV field configuration associated with the downlink control information message.

In some examples of the method, network entities, and non-transitory computer-readable medium described herein, transmitting the downlink control information message may include operations, features, means, or instructions for transmitting, via the downlink control information message, a single RV field that indicates an RV for decoding the two or more transport blocks and transmitting, via the downlink control information message, two or more MCS fields that correspond to the two or more transport blocks, where respective values of the two or more MCS fields indicate which one or more transport blocks, of the two or more transport blocks, may be scheduled via the downlink control information message based on the downlink control information message including the single RV field.

In some examples of the method, network entities, and non-transitory computer-readable medium described herein, communicating the at least one transport block may include operations, features, means, or instructions for communicating one transport block of the two or more transport blocks, the one transport block being scheduled by the downlink control information message based on a rule for transport block scheduling in accordance with a value of the two or more MCS fields being associated with a same value for disabling respective transport blocks.

In some examples of the method, network entities, and non-transitory computer-readable medium described herein, communicating the at least one transport block may include operations, features, means, or instructions for communicating two transport blocks scheduled by the downlink control information message based on the respective values of each of the two or more MCS fields including a same value that may be associated with disabling a transport block.

In some examples of the method, network entities, and non-transitory computer-readable medium described herein, transmitting the downlink control information message may include operations, features, means, or instructions for transmitting, via the downlink control information message, a scheduling quantity field that indicates a quantity of transport blocks, of the two or more transport blocks, that may be scheduled by the downlink control information message, where respective sizes of one or more fields of the downlink control information message, respective values of the one or more fields of the downlink control information message, or any combination thereof may be based on the scheduling quantity field.

In some examples of the method, network entities, and non-transitory computer-readable medium described herein, the scheduling quantity field includes a bitmap and each bit of the bitmap indicates whether a corresponding transport block of the two or more transport blocks may be scheduled by the downlink control information message or may be disabled.

In some examples of the method, network entities, and non-transitory computer-readable medium described herein, transmitting the downlink control information message may include operations, features, means, or instructions for transmitting, via the downlink control information message, one or more zero-padding bits based on the quantity of transport blocks indicated by the scheduling quantity field.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multi-transport block scheduling in accordance with one or more aspects of the present disclosure.

FIG. 2 shows an example of a wireless communications system that supports multi-transport block scheduling in accordance with one or more aspects of the present disclosure.

FIG. 3 shows an example of a process flow that supports multi-transport block scheduling in accordance with one or more aspects of the present disclosure.

FIGS. 4 and 5 show block diagrams of devices that support multi-transport block scheduling in accordance with one or more aspects of the present disclosure.

FIG. 6 shows a block diagram of a communications manager that supports multi-transport block scheduling in accordance with one or more aspects of the present disclosure.

FIG. 7 shows a diagram of a system including a device that supports multi-transport block scheduling in accordance with one or more aspects of the present disclosure.

FIGS. 8 and 9 show block diagrams of devices that support multi-transport block scheduling in accordance with one or more aspects of the present disclosure.

FIG. 10 shows a block diagram of a communications manager that supports multi-transport block scheduling in accordance with one or more aspects of the present disclosure.

FIG. 11 shows a diagram of a system including a device that supports multi-transport block scheduling in accordance with one or more aspects of the present disclosure.

FIGS. 12 through 15 show flowcharts illustrating methods that support multi-transport block scheduling in accordance with one or more aspects of the present disclosure.

### DETAILED DESCRIPTION

In some wireless communications systems, a user equipment (UE) and a network entity may use spatial multiplexing to communicate multiple transport blocks over a set of time-frequency resources using different spatial layers. For example, a network entity may transmit a first transport block over physical downlink shared channel (PDSCH) resources using a first set of spatial layers and a second transport block over the PDSCH resources (e.g., the same time-frequency PDSCH resources) using a second set of spatial layers. In some cases, the network entity may configure the UE for spatial bundling of feedback, such as hybrid automatic repeat request (HARQ) feedback. When configured with spatial bundling for feedback, the UE may combine acknowledgement feedback for multiple transport blocks into a single field. For example, if the UE is configured for spatial bundling (e.g., spatial bundling is enabled at the UE), the UE may transmit uplink control information indicating a single feedback bit for the multiple transport blocks, such as multiple transport blocks multiplexed in time, frequency, space, or any combination thereof. The network entity may transmit downlink control information to schedule the UE to communicate (e.g., transmit or receive) multiple transport blocks. In some examples, the downlink control information may include information for each scheduled transport block, such as separate modulation and coding scheme (MCS) information, separate redundancy version (RV) information, and separate new data indicator (NDI) values. The downlink control information indicating this information separately for each scheduled transport block may correspond to a relatively high amount of overhead.

Wireless communications systems described herein may support techniques to reduce overhead for control signaling to schedule multiple transport blocks, such as multiple spatially multiplexed transport blocks. For example, if a UE is configured to perform spatial bundling for feedback of multi-transport block PDSCH, downlink control information that schedules the multi-transport block PDSCH may include a single NDI field, which is applied for each transport block of the multiple transport blocks. In some examples, if the NDI field is toggled (e.g., changed) for an indicated HARQ identifier, the UE may assume each transport block of the multiple, scheduled transport blocks include an initial transmission (e.g., and not a retransmission). In some examples, if the NDI field is not toggled (e.g., not changed) for an indicated HARQ identifier, the UE may assume each transport block of the multiple, scheduled transport blocks is a retransmission. In some examples, downlink control information that schedules multiple transport blocks (e.g., multiple spatially multiplexed transport blocks) may indicate a single RV field, which is applied for each transport block of the multiple transport blocks. Additional, or alternative, techniques related to switching between multi-transport block scheduling and single-transport block scheduling, disabling one or more transport blocks of a scheduled multi-transport block transmission, and indicating a quantity of scheduled transport blocks in a multi-transport block communication are described.

Aspects of the disclosure are initially described in the context of wireless communications systems. Aspects of the disclosure are further illustrated by and described with reference to a process flow, apparatus diagrams, system diagrams, and flowcharts that relate to multi-transport block scheduling.

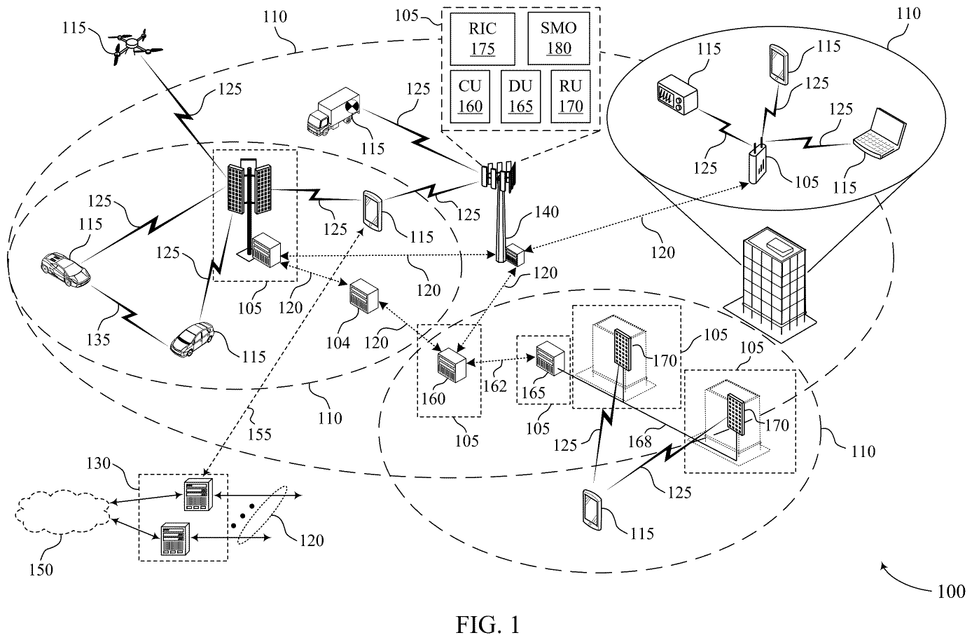

FIG. 1 shows an example of a wireless communications system 100 that supports multi-transport block scheduling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support multi-transport block scheduling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support multi-code word or multi-transport block communication using spatial multiplexing. In some wireless communications systems, a wireless device, such as a UE 115 or a network entity 105, may transmit a single transport block or codeword when the wireless device is configured to transmit using up to four spatial layers. If the wireless device is configured to transmit using more than four layers, the wireless device may map multiple transport blocks or codewords (e.g., two transport blocks or codewords) to different layers of one shared channel (e.g., a physical uplink shared channel (PUSCH) for uplink communications or a PDSCH for downlink communications).

In some examples, a transport block may include one or more code blocks. For example, a transport block may include multiple code blocks, and a transmitting device and a receiving device may perform encoding and decoding, respectively, per code block. In some examples, a transmitting device and a receiving device may communicate multiple transport blocks (e.g., multi-transport block communications) or multiple codewords (e.g., multi-codeword communications), or both. In some examples, transport block and codeword may be used interchangeably. For example, techniques described herein may be implemented for communication of transport blocks or codewords, or both.

If the transmitting device is configured to transmit using more than four layers, modulated symbols of a first codeword may be mapped to a first set of layers, and modulated symbols of a second codeword may be mapped to a second set of layers. For example, the transmitting device may be configured to transmit using a quantity of layers, v, which is greater than four. Modulated symbols of a first codeword (e.g., CW0, including

$${M}_{s y m b}^{( 0 )}$$

modulated symbols) may be mapped to a first

$$⌊ \frac{v}{2} ⌋$$

layers, and modulated symbols of a second codeword (e.g., CW1, including

$${M}_{symb}^{( 1 )}$$

modulated symbols) may be mapped to the remaining

$$⌈ \frac{v}{2} ⌉$$

layers. For example, for five layers, the modulated symbols of CW0 may be mapped to a first two layers, and the modulated symbols of CW1 may be mapped to the remaining three layers.

In some wireless communications systems, a network entity 105 may transmit downlink control information to schedule a UE 115 for a multi-transport block communication. For example, the UE 115 may be scheduled to transmit two transport blocks via a PUSCH resource, or the UE 115 may be scheduled to receive two transport blocks via a PDSCH resource. In some of these systems, the downlink control information to schedule the two transport blocks may include two respective MCS values, two respective RV values, and two respective NDIs for the two transport blocks. In some examples, some other parameters, such as a frequency domain resource allocation (FDRA), a time domain resource allocation (TDRA), and a HARQ identifier may be the same for the two transport blocks.

In some examples, a device transmitting multiple transport blocks may map coded bits of each transport block according to layer, then frequency, then time. For example, for a shared channel resource with a relatively large frequency allocation, the device may transmit two transport blocks, or two portions of two transport blocks. Within one OFDM symbol, a first code block and a second code block of the first transport block may be each be mapped different resource blocks and be mapped to a first two layers. Within that OFDM symbol, a first code block, a second code block, and a third code block of the second transport block may each be mapped to different resource blocks and be mapped to a next three layers. In some examples, the code blocks of the second transport block may overlap in the frequency domain with the code blocks of the first transport block. For a shared channel resource with a relatively small frequency allocation, a first code block of a first transport block may be mapped to a first two layers and a set of resource blocks and span three OFDM symbols, and a first code block of a second transport block may be mapped the next three layers and the same resource blocks and span the same three OFDM symbols.

In some examples, the wireless communications system 100 may support multi-transport block communications for a smaller quantity of spatial streams or lower-rank communications. For example, a transmitting device may transmit multiple transport blocks (e.g., multiple spatially multiplexed transport blocks) with two or more layers (e.g., rank 2 signaling or higher).

In some examples, the wireless communications system 100 may support spatial bundling for feedback, such as ARQ feedback or HARQ feedback. If a UE 115 is configured for spatial bundling for feedback, the UE 115 may combine acknowledgement feedback for multiple transport blocks into a single field (for example, into a single bit). For example, if the UE 115 is configured for spatial bundling of HARQ feedback, the UE 115 may not send separate HARQ feedback for two transport blocks that are transmitted according to a multi-transport block communication (e.g., spatially multiplexed as described herein). If configured for spatial bundling (e.g., spatial bundling is enabled at the UE 115), the UE 115 may transmit uplink control information indicating a single feedback bit for the multiple transport blocks.

A network entity 105 may transmit downlink control information to schedule a UE 115 to communicate (e.g., transmit or receive) multiple transport blocks. In some examples, the downlink control information may include information for each scheduled transport block, such as separate MCS information, separate RV information, and separate NDI values. The downlink control information indicating this information separately for each scheduled transport block may correspond to a relatively high amount of overhead.

The wireless communications system 100 may support techniques to reduce overhead for control signaling to schedule multiple transport blocks, such as multiple spatially multiplexed transport blocks. For example, if a UE 115 is configured to perform spatial bundling for feedback of multi-transport block PDSCH, downlink control information that schedules the multi-transport block PDSCH may include a single NDI field. The single NDI field may be applied for each transport block of the multiple transport blocks. In some examples, if the NDI field is toggled (e.g., changed) for an indicated HARQ identifier, the UE 115 may assume each transport block of the multiple, scheduled transport blocks include an initial transmission (e.g., and not a retransmission). In some examples, if the NDI field is not toggled (e.g., not changed) for an indicated HARQ identifier, the UE 115 may assume each transport block of the multiple, scheduled transport blocks is a retransmission.

In some examples, downlink control information that schedules multiple transport blocks (e.g., multiple spatially multiplexed transport blocks) may indicate a single RV field. The single RV field may be applied for each transport block of the multiple transport blocks. Additional, or alternative, techniques related to switching between multi-transport block scheduling and single-transport block scheduling, disabling one or more transport blocks of a scheduled multi-transport block transmission, and indicating a quantity of scheduled transport blocks in a multi-transport block communication are described.

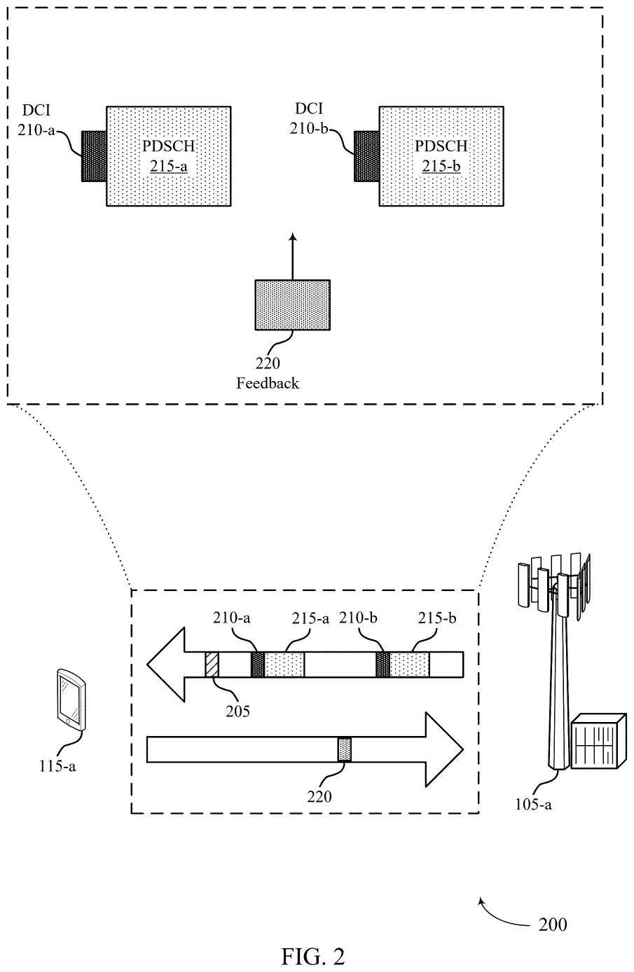

FIG. 2 shows an example of a wireless communications system 200 that supports multi-transport block scheduling in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The network entity 105-a and the UE 115-a may communicate multiple, spatially multiplexed transport blocks via a shared channel resource. For example, the network entity 105-a may transmit multiple spatially multiplexed transport blocks or multiple codewords to the UE 115-a via a downlink shared channel resource, or the UE 115-a may transmit multiple spatially multiplexed transport blocks or codewords to the network entity 105-a via an uplink shared channel resource. The different transport blocks may be mapped to different spatial layers and may be transmitted on at least partially overlapping time domain resources, frequency domain resources, or both, of the shared channel resource.

In some examples, the network entity 105-a may transmit control signaling 205 to the UE 115-a that enables spatial bundling techniques. For example, the control signaling 205 may configure the UE 115-a for spatial bundling for HARQ feedback. For spatial bundling for feedback, the UE 115-a may bundle HARQ feedback for multiple transport blocks, for example indicating feedback for the multiple transport blocks with a single feedback field or a single feedback bit.

In some examples, the control signaling 205 may configure the UE 115-a for spatial bundling for HARQ feedback associated with PUCCH signaling. For example, the control signaling 205 may configure (e.g., enable) the UE 115-a to transmit HARQ feedback in accordance with spatial bundling via PUCCH signaling. Additionally, or alternatively, the control signaling 205 may configure the UE 115-a for spatial bundling for HARQ feedback associated with PUSCH signaling. For example, the control signaling 205 may configure (e.g., enable) the UE 115-a to transmit HARQ feedback in accordance with spatial bundling via PUSCH signaling, such as if the UE 115-a multiplexes uplink control information including the HARQ feedback with a PUSCH transmission. In some examples, the UE 115-a may be configured for spatial bundling if the UE 115-a is configured for spatial bundling of HARQ feedback over PUCCH and the UE 115-a is configured for spatial bundling of HARQ feedback over PUSCH.

The network entity 105-a may transmit downlink control information 210 to schedule the UE 115-a for multiple transport blocks. For example, the downlink control information 210 may schedule the UE 115-a for multiple transport blocks via a downlink shared channel, such as a PDSCH 215. In some examples, the multiple transport blocks may be spatially multiplexed as described herein. The downlink control information 210 may include an identifier of a HARQ process associated with the multiple transport blocks.

If the UE 115-a is configured with spatial bundling for feedback of a multi-transport block PDSCH, the downlink control information 210 may include a single NDI field. For example, the network entity 105-a may transmit first downlink control information 210-a (e.g., downlink control information 210-a in FIG. 2) to schedule multiple transport blocks for a PDSCH 215-a, and the first downlink control information 210-a may include a single NDI field that is associated with each transport block of the multiple transport blocks. The network entity 105-a may schedule the UE 115-a for a first transport block (e.g., TB0) and a second transport block (e.g., TB1) over the PDSCH 215-a, and the first downlink control information 210-a may include a single NDI that is applied for both the first transport block and the second transport block.

The UE 115-a may determine whether transport blocks of a multi-transport block transmission associated with a HARQ process are initial transmissions or retransmissions based on whether the NDI of the downlink control information 210 is toggled. For example, if the NDI in the downlink control information 210 is toggled (e.g., changed) for an indicated HARQ identifier, the multiple the UE 115-a may determine (e.g., assume) that the scheduled transport blocks are initial transmissions. If the NDI in the downlink control information 210 is not toggled (e.g., not changed) for the indicated HARQ identifier, the UE 115-a may determine (e.g., assume) that the transport blocks are retransmissions.

In some examples, whether the NDI is toggled or changed may be with respect to a previous NDI associated with the HARQ identifier. For example, the NDI may be a single bit. First downlink control information 210-a may indicate an NDI value of ‘0’ for a first HARQ identifier, and second downlink control information 210-b (e.g., downlink control information 210-b in FIG. 2) may indicate an NDI value of ‘0’ for the first HARQ identifier, the UE 115-a may determine that the transport blocks scheduled by the second downlink control information for PDSCH 215-b are retransmissions of the transport blocks transmitted via PDSCH 215-a. In some other examples, if the first downlink control information 210-a indicates an NDI value of ‘1’ for the first HARQ identifier, and the second downlink control information 210-b indicates an NDI value of ‘0’ for the first HARQ identifier, the UE 115-a may determine that the transport blocks scheduled for the PDSCH 215-b by the second downlink control information 210-b are initial transmissions and not retransmissions of the transport blocks transmitted via the PDSCH 215-a.

In some examples, the NDI field may include one bit. If the NDI field includes one bit, a value of the NDI field may be toggled (e.g., changed or switched) to indicate new data to the UE 115-a. In some other examples, the NDI field may include two bits. The NDI field may be incremented or modified based on a modulo 4 operation to indicate new data. For example, an NDI field for a HARQ identifier may change from a value of ‘01’ in the first downlink control information 210-a to a value of ‘10’ in the second downlink control information 210-b to indicate that the transport blocks scheduled by the second downlink control information 210-b are initial transmissions.

For example, the network entity 105-a may transmit, and the UE 115-a may receive, the first downlink control information 210-a scheduling the UE 115-a for multiple transport blocks over the PDSCH 215-a. The first downlink control information 210-a may include a single NDI field associated with each transport block of the multiple transport blocks and include a HARQ identifier, for example based on the UE 115-a being configured for spatial bundling for HARQ feedback. The UE 115-a may receive the multiple transport blocks via the PDSCH 215-a.

The UE 115-a may transmit a feedback message 220. The feedback message 220 may be an example of uplink control information that indicates HARQ feedback for the multiple transport blocks scheduled by the first downlink control information 210-a. In some examples, the UE 115-a may transmit the feedback message 220 via PUCCH, or the UE 115-a may transmit the feedback message 220 via PUSCH (e.g., multiplexing the uplink control information with a PUSCH transmission). The UE 115-a may be configured for spatial bundling based on the control signaling 205, and the UE 115-a may bundle HARQ feedback for each of the multiple transport blocks together. For example, the UE 115-a may transmit a single bit of HARQ feedback to indicate an acknowledgement or a negative acknowledgement. In some examples, the UE 115-a may indicate an acknowledgement if the UE 115-a successfully decoded each of the multiple transport blocks, and the UE 115-a may indicate a negative acknowledgement if the UE 115-a did not receive or successfully decode at least one transport block of the multiple transport blocks.

The network entity 105-a may transmit, and the UE 115-a may receive, the second downlink control information 210-b scheduling the UE 115-a for multiple transport blocks over the PDSCH 215-b. The second downlink control information 210-b may include a single NDI field associated with each transport block of the multiple transport blocks scheduled for the PDSCH 215-b, for example based on the UE 115-a being configured for spatial bundling of HARQ feedback, and indicate a HARQ process identifier. For example, the second downlink control information 210-b may indicate a same HARQ identifier as the first downlink control information 210-a. The UE 115-a may determine whether the multiple transport blocks scheduled by the second downlink control information 210-b are initial transmissions or retransmissions based on whether the NDI of the second downlink control information 210-b is toggled (e.g., changed) from the NDI of the first downlink control information 210-a.

In some examples, the network entity 105-a and the UE 115-a may switch between multi-transport block communications and single-transport block communications. For example, the first downlink control information 210-a may schedule the UE 115-a for a single transport block via the PDSCH 215-a. The UE 115-a may unsuccessfully decode the transport block and transmit the feedback message 220 indicate a negative acknowledgement for the transport block. The wireless communications system 200 may support techniques for HARQ retransmission when switching between multi-transport block communications and single-transport block communications.

For example, the network entity 105-a may transmit the second downlink control information 210-b scheduling multiple transport blocks. The second downlink control information 210-b may indicate a same HARQ identifier as the first downlink control information 210-a, which may have scheduled a single transport block.

In some examples, the UE 115-a may expect the NDI of the second downlink control information 210-b, scheduling multiple transport blocks, to be toggled compared to the NDI of the first downlink control information 210-a, which scheduled a single transport block. For example, if the NDI of the second downlink control information 210-b is not toggled compared to the NDI of the first downlink control information 210-a (e.g., the NDI value is the same in both downlink control information), the UE 115-a may detect an error case.

In some examples, the UE 115-a may assume the NDI of the second downlink control information 210-b is toggled, regardless of the NDI value of the second downlink control information 210-b. The UE 115-a may flush a HARQ buffer associated with HARQ identifier, and all scheduled transport blocks scheduled by the second downlink control information 210-b (e.g., the next downlink control information received after the first downlink control information 210-a scheduling a single transport block for the same HARQ identifier) are assumed to be initial transmissions.

In some examples, if the NDI of the second downlink control information 210-b is the same as the NDI of the first downlink control information 210-a, the UE 115-a may determine (e.g., assume) that a first scheduled transport block is a retransmission of the single transport block, and other transport blocks of the multi-transport block transmission are new or initial transmissions. For example, the first downlink control information 210-a, scheduling a single transport block, and the second downlink control information 210-b, scheduling multiple transport blocks, may indicate a same HARQ identifier and have a same NDI value. The UE 115-a may determine (e.g., assume) that one transport block of the multiple transport blocks scheduled by the second downlink control information 210-b is a retransmission of the single transport block scheduled by the first downlink control information 210-a. The UE 115-a may determine (e.g., assume) that the other transport blocks of the multiple transport blocks scheduled by the second downlink control information 210-b are new or initial transmissions. For example, the UE 115-a may effectively assume that the NDI is not toggled for a first transport block of the multiple transport blocks but is toggled for the other transport blocks.

In some examples, a downlink control information 210 that schedules multiple transport blocks may include a single RV field that is applied to each of the multiple transport blocks. In some examples, the network entity 105-a may configure (e.g., via the control signaling 205) whether the downlink control information 210 includes a single RV field or multiple RV fields. The network entity 105-a may configure different quantity of RV fields for different downlink control information formats separately for each component carrier. In some examples, having separate configurations for quantities of RV fields in downlink control information may provide scheduling flexibility for the network entity 105-a. For example, the network entity 105-a may indicate an RV per codeword or per transport block if the RV for retransmission is determined by a scheduler based on MCS or code rate of the previous transmission of the transport block. The network entity 105-a may switch between indicating a single RV in downlink control information (e.g., for reduced overhead) or indicating multiple RVs in downlink control information (e.g., for scheduling flexibility) based on conditions at the network entity 105-a.

In some wireless communications systems, one transport block of a multi-transport block transmission may be disabled based on MCS and RV field values indicated for that transport block. For example, if a higher layer parameter indicates that two codeword transmissions are enabled, one of the two transport blocks may be disabled by downlink control information (e.g., having downlink control information format 1_1) if an MCS value associated with the transport block is set to a specific value (e.g., MCS value of ‘26’) and an RV value associated with the transport block is set to a specific value (e.g., RV value of ‘1’). For example, if the downlink control information indicates an MCS and an RV value for each transport block, and the MCS and the RV value for a transport block are set to those specific values, that transport block may be disabled. If both transport blocks are enabled, the first and second transport blocks may be mapped to a first and second codeword, respectively. If only one transport block is enabled, the enabled transport block may be mapped to the first codeword.

Disabling a transport block may be used to determine a quantity of scheduled codewords, which may be used for interpretation of the antenna port fields (e.g., that indicates the rank and demodulation reference signal (DMRS) ports). Additionally, or alternatively, disabling a transport block may be used for transport block retransmission. For example, after one or more multi-codeword schedulings, one or more downlink control information may schedule single-codeword PDSCH. The UE 115-a may identify which of the transport blocks are rescheduled for retransmission the downlink control information scheduling single-codeword PDSCH based on which transport block is disabled.

The wireless communications system 200 provides techniques for disabling a transport block using a single RV field in downlink control information that schedules a shared channel for multi-transport block communication. The downlink control information may include an MCS field for each transport block of the multi-transport block communication. If an MCS field associated with a transport block is set to particular value, that transport block may be disabled. For example, if a downlink control information 210 includes two MCS fields associated with two transport blocks, and a first MCS field associated with a first transport block is set to a specific value, the first transport block may be disabled. For example, if the first MCS field associated with a first transport block is set to 26, and a second MCS field associated with a second transport block is set to another value (e.g., not 26), the first transport block may be disabled, and the second transport block may be scheduled.

In some examples, multiple MCS fields associated with multiple respective transport blocks may be set to the specific value. For example, a first MCS field associated with a first transport block and a second MCS field associated with a second transport block may each be set to the specific value. In some examples, if both MCS fields indicate the particular value, the UE 115-a may determine (e.g., assume) that both transport blocks are scheduled. In some examples, if both MCS fields indicate the particular value, the UE 115-a may determine (e.g., assume) that the first transport block is scheduled, and the second transport block is disabled. In some examples, if both MCS fields indicate the particular value, the UE 115-a may determine (e.g., assume) that the first transport block is disabled, and the second transport block is scheduled. In some examples, if both MCS fields indicate the particular value, the UE 115-a may detect an error. These techniques may enable the network entity 105-a to schedule a transport block using the particular value for the MCS field.

In some examples, a downlink control information 210 may include a field that indicates a quantity of scheduled codewords out of a threshold quantity of codewords. For example, the downlink control information 210 may indicate a quantity of scheduled codewords out of a maximum supported quantity of codewords, M. A size of the downlink control information 210 may be based on a maximum of, or a larger size between, a downlink control information size for scheduling a multi-codeword shared channel and a downlink control information size for scheduling a single codeword.

In some examples, the field to indicate the quantity of scheduled codewords may be a bitmap. In some examples, the bitmap include M bits, or a quantity of bits corresponding to the threshold quantity of codewords. Each bit of the bitmap may correspond to a different codeword of the M threshold quantity of codewords. This technique may support retransmission of an arbitrary subset of codewords based on the downlink control information 210 indicating which specific codewords are scheduled. For example, an mth bit of the bitmap may indicate whether an mth codeword is scheduled or not. In some examples, the bitmap may include [log₂ M] bits. For example, the bitmap may indicate a quantity of scheduled codewords.

In some examples, other fields of the downlink control information 210 may be based on a value of the field which indicates the quantity of scheduled codewords. For example, the UE 115-a may interpret a field indicating antenna ports, MCS fields (e.g., a quantity of MCS fields), a quantity of NDI fields, a quantity of RV fields, and a size or interpretation of a code block group (CBG) transmission indicator (CBGTI) field (e.g., if present) of the downlink control information 210 based on a value of the field indicating the quantity of scheduled codewords. For example, if the field indicating the quantity of scheduled codewords in the downlink control information 210 indicates one scheduled codeword, the UE 115-a may determine there is one MCS field in the downlink control information 210. If the field indicating the quantity of scheduled codewords in the downlink control information 210 indicates multiple scheduled codewords, the UE 115-a may determine there are multiple MCS fields in the downlink control information 210. The UE 115-a may interpret or decode the downlink control information 210 accordingly.

In some examples, downlink control information size alignment may be based on different sizes of downlink control information that schedule different quantities of codewords. For example, downlink control information size alignment may be based on a maximum of a first size of a downlink control information that schedules a single codeword, a second size of a downlink control information that schedules two codewords, and through an Mth size of a downlink control information that schedules M codewords. The network entity 105-a may perform zero-padding (e.g., at the end of the downlink control information 210) to match or align the sizes of these different cases. For example, if a downlink control information that schedules M codewords has a largest size, downlink control information that schedule other quantities of codewords may be zero-padded to be the same size. The size (e.g., the zero-padding procedure) may be determined based on Equation (1), where Cₘ is a size of the downlink control information fields (e.g., antenna port fields) that are a function of the quantity of scheduled codewords m, X is a size of all the downlink control information fields (e.g., MCS, NDI, RV) that may be indicated separately for each of the scheduled codewords, and Y is a size of fields that are not based on the quantity of scheduled codewords.

$${max}_{m = 1 , 2 , … M} ( {C}_{m} + m * X + Y ) \qquad ( 1 )$$

In an example, the network entity 105-a may transmit downlink control information 210 including the field that indicates the quantity of scheduled codewords. In some examples, a maximum quantity of scheduled codewords may be 2, or M is set to 2, and the field may include two bits. For a first value of the field (e.g., set to ‘10’), the field may indicate that a first codeword is scheduled. For a second value of the field (e.g., set to ‘01’), the field may indicate that a second codeword is scheduled. For a third value of the field (e.g., set to ‘11’), the field may indicate that both codewords are scheduled. For the first value of the field and the second value of the field, where only one codeword of the maximum quantity of codewords is scheduled, the downlink control information 210 may include an antenna port indication field with five bits. For the third value of the field, where both codewords (e.g., the maximum quantity of codewords) are scheduled, the downlink control information 210 may include an antenna port indication field with two bits.

The field to indicate the quantity of scheduled codewords may be implemented with the techniques to reduce downlink control information overhead by using a single NDI value or a single RV value, or both, for multi-transport block scheduling. The field to indicate the quantity of scheduled codewords may also reduce downlink control information overhead. For example, when implemented with techniques to indicate a single NDI and a single RV for multi-transport block scheduling, the downlink control information 210 may include 17 bits according to Equation (1), where 2+max {5+5+1+2, 2+2*5+1+2}=17 bits. When implemented without techniques to indicate a single NDI and a single RV for multi-transport block scheduling, the downlink control information 210 may include 20 bits according to Equation (1), where 2+max {5+5+1+2,2+2*(5+1+2)}=20 bits. Other wireless communications systems which do not use the field to indicate the quantity of scheduled codewords, and therefore other fields of the downlink control information are not based on the field which indicates the quantity of scheduled codewords, may use 21 bits for the downlink control information.

In some examples, these techniques may be applied for FDMed or TDMed transport blocks. For example, multiple transport blocks or codewords may be FDMed or TDMed, or both, and the UE 115-a may provide HARQ feedback for the multiple FDMed or TDMed transport blocks or codewords according to the techniques described herein. The UE 115-a may bundle HARQ feedback of two or more transport blocks (e.g., scheduled by one downlink control information 210) that are communicated via different resource blocks, subbands, or component carriers FDMed transport blocks. Additionally, or alternatively, the UE 115-a may bundle HARQ feedback of two or more transport blocks that are communicated via different slots or symbols. Downlink control information 210 that schedules the multiple FDMed or TDMed transport blocks may include a single NDI field or a single RV field, or both. In some examples, these techniques may correspond to frequency bundling, component carrier bundling, or time bundling of HARQ feedback. In some examples, downlink control information 210 may similarly be configured (e.g., as described with reference to spatial bundling) if a UE 115 is configured for frequency bundling, component carrier bundling, or time bundling, or any combination thereof.

While these techniques are generally described with reference to the network entity 105-a transmitting multiple transport blocks via a downlink shared channel resource, these techniques may also be implemented for the UE 115-a transmitting multiple transport blocks via an uplink shared channel resource. For example, the network entity 105-a may transmit downlink control information 210 that schedules the UE 115-a for a multi-transport block transmission via and uplink shared channel resource. In some examples, the downlink control information 210 scheduling the UE 115-a for the multi-transport block transmission may include a single NDI for a multi-transport block transmission, a single RV for a multi-transport block transmission, a field that indicates quantity of scheduled codewords, or any combination thereof.

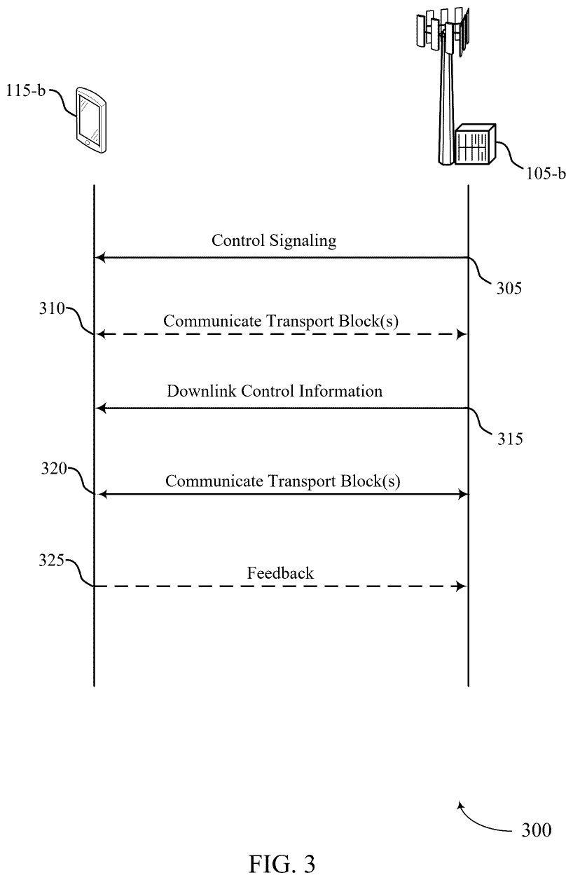

FIG. 3 shows an example of a process flow 300 that supports multi-transport block scheduling in accordance with one or more aspects of the present disclosure. The process flow 300 may include aspects of a wireless communications system 100 or a wireless communications system 200. For example, the process flow 300 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the network entity 105-b may transmit, and the UE 115-b may receive, control signaling that enables a spatial bundling feature for feedback. In some examples, the control signaling may enable the UE 115-b to performing spatial bundling of feedback for multiple transport blocks. For example, the UE 115-b may receive, via the control signaling, one or more feedback configuration fields that enable the spatial bundling feature for feedback associated with a control channel and that enable feedback associated with a shared channel. For example, the UE 115-b may be configured to report a single feedback bit for multiple transport blocks that are scheduled on a shared channel resource, and the UE 115-b may be enabled to report the feedback over an uplink control channel or over an uplink shared channel, or both. In some examples, the control signaling may be an example of higher layer signaling, such as RRC signaling.

In some examples, these techniques may be based on other bundling features for feedback. For example, the UE 115-b may be configured for frequency bundling or time bundling, or both. The UE 115-b may be scheduled for multiple frequency division multiplexed or time division multiplexed transport blocks by a single downlink control information, and the UE 115-b may report bundled feedback for the multiple transport blocks.

In some examples, the UE 115-b and the network entity 105-b may communicate one or more transport blocks at 310. For example, the network entity 105-b may transmit the one or more transport blocks to the UE 115-b. In some examples, the one or more transport blocks communicated at 310 may be scheduled by a downlink control information message as described herein.

At 315, the network entity 105-b may transmit, and the UE 115-b may receive, a downlink control information message. The downlink control information message may include a single NDI field associated with two or more transport blocks based on the spatial bundling feature being active. The single NDI field may indicate whether the two or more transport blocks include data that is the same or different from previous data conveyed via one or more previous transport blocks (e.g., the one or more transport blocks communicated at 310).

In some examples, the single NDI field may indicate whether the two or more transport blocks include data that is the same as or different from previous data conveyed via the one or more previous transport blocks (e.g., at 310) based on the one or more previous transport blocks and the two or more transport blocks being associated with a same HARQ identifier. For example, the downlink control information may include a HARQ identifier. If the single NDI field is the same (e.g., untoggled) from an NDI field of a previous downlink control information that indicated the same HARQ identifier, the downlink control information received at 315 may schedule a retransmission of at least one transport block scheduled by the previous downlink control information. If the single NDI field is the different (e.g., toggled) from the NDI field of the previous downlink control information that indicated the same HARQ identifier, the downlink control information received at 315 may schedule initial transmissions of transport blocks (e.g., and not retransmissions of previously communicated transport blocks).

In some examples, the downlink control information message may include a single RV field. The single RV field may indicate an RV for decoding the two or more transport blocks. In some examples, the UE 115-b may receive second control signaling that indicates one or more RV field configurations for one or more downlink control information formats. The downlink control information message may include the single RV field based on an RV field configuration associated with the downlink control information message.

In some examples, the downlink control information message may include a field to indicate a quantity of scheduled codewords or a quantity of scheduled transport blocks, or both. In some examples, the field may be referred to as a scheduling field. The scheduling field may indicate a quantity of transport blocks, of the two or more transport blocks, that are scheduled by the downlink control information message. In some examples, respective sizes of one or more fields of the downlink control information message, respective values of the one or more fields of the downlink control information message, or any combination thereof are based on the scheduling quantity field. In some examples, the scheduling field may include a bitmap. In some examples, each bit of the bitmap may indicate whether a corresponding transport block of the two or more transport blocks is scheduled by the downlink control information message or is disabled. In some other examples, a value of the bitmap may correspond to a quantity of scheduled transport blocks of the two or more transport blocks.

In some examples, the downlink control information may include one or more zero-padding bits. For example, the UE 115-b may receive one or more zero-padding bits based on the quantity of transport blocks indicated by the scheduling quantity field. In some examples, a quantity of the zero-padding bits may be based on a threshold (e.g., maximum) size for a downlink control information scheduling one or more transport blocks. In some examples, the downlink control information message may include a quantity of bits that is based on a maximum size from among one or more candidate sizes associated with one or more values of the scheduling quantity field.

At 320, the UE 115-b and the network entity 105-b may communicate at least one transport block of the two or more transport blocks according to the downlink control information message and the single NDI field. In some examples, the network entity 105-b may transmit the at least one transport block, and the UE 115-b may receive the at least one transport block. In some other examples, UE 115-b may transmit the at least one transport block, and the network entity 105-b may receive the at least one transport block.

At 325, the UE 115-b may transmit, and the network entity 105-b may receive, a single feedback message that indicates combined feedback for the two or more transport blocks. For example, the UE 115-b may transmit the single feedback message indicating combined feedback for the two or more transport blocks in accordance with the spatial bundling feature being enabled and a value of the single NDI field.

In some examples, the one or more transport blocks communicated at 310 may include a single transport block. For example, the UE 115-b and the network entity 105-b may communicate the one or more previous transport blocks that convey the previous data, and the one or more previous transport blocks may include a single previous transport block that is associated with a previous NDI field. Communicating the two or more transport blocks at 320 may include decoding the two or more transport blocks based on the previous NDI field including a different value than the single NDI field associated with the two or more transport blocks. In some other examples, the UE 115-b may determine that the two or more transport blocks correspond to new transmissions irrespective of a value of the single NDI field based on the one or more previous transport blocks including the single previous transport block. In some other examples, the UE 115-b may determine that the two or more transport blocks correspond to retransmissions of the previous data based on the single NDI field including a same value as the previous NDI field.

In some examples, the downlink control information message received by the UE 115-b at 315 may include a single RV field that indicates an RV for decoding the two or more transport blocks communicated at 320. The UE 115-b may receive, via the downlink control information message, two or more MCS fields that correspond to the two or more transport blocks. In some examples, respective values of the two or more MCS fields may indicate which one or more transport blocks, of the two or more transport blocks, are scheduled via the downlink control information message based on the downlink control information message including the single RV field. In some examples, the UE 115-b and the network entity 105-b may communicate one transport block of the two or more transport blocks, the one transport block being scheduled by the downlink control information message based on a rule for transport block scheduling in accordance with a value of the two or more MCS fields being associated with a same value for disabling respective transport blocks. In some other examples, the UE 115-b and the network entity 105-b may communicate two transport blocks scheduled by the downlink control information message based on the respective values of each of the two or more MCS fields including a same value that is associated with disabling a transport block.

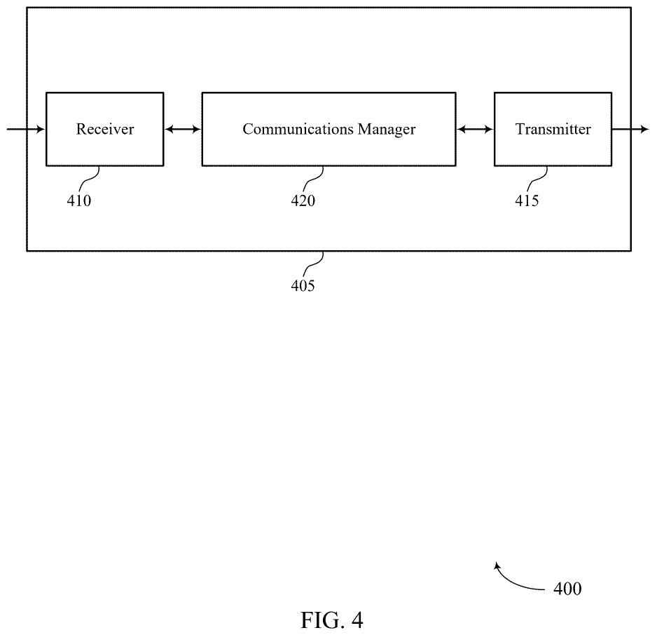

FIG. 4 shows a block diagram 400 of a device 405 that supports multi-transport block scheduling in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to multi-transport block scheduling). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to multi-transport block scheduling). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of multi-transport block scheduling as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving control signaling that enables a spatial bundling feature for feedback. The communications manager 420 is capable of, configured to, or operable to support a means for receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The communications manager 420 is capable of, configured to, or operable to support a means for communicating at least one transport block of the two or more transport blocks according to the downlink control information message and the single NDI field.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and more efficient utilization of communication resources.

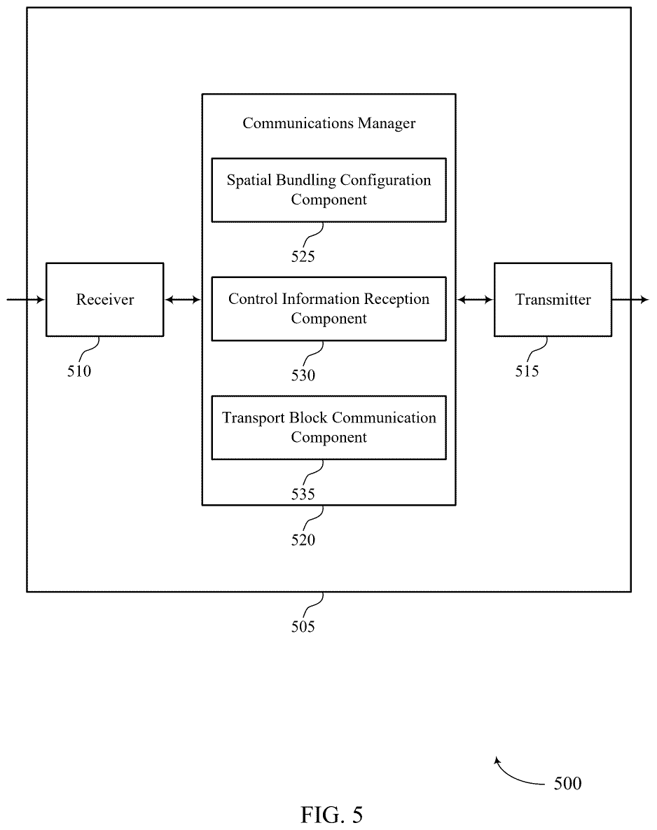

FIG. 5 shows a block diagram 500 of a device 505 that supports multi-transport block scheduling in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to multi-transport block scheduling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multi-transport block scheduling). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of multi-transport block scheduling as described herein. For example, the communications manager 520 may include a spatial bundling configuration component 525, a control information reception component 530, a transport block communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The spatial bundling configuration component 525 is capable of, configured to, or operable to support a means for receiving control signaling that enables a spatial bundling feature for feedback. The control information reception component 530 is capable of, configured to, or operable to support a means for receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The transport block communication component 535 is capable of, configured to, or operable to support a means for communicating at least one transport block of the two or more transport blocks according to the downlink control information message and the single NDI field.

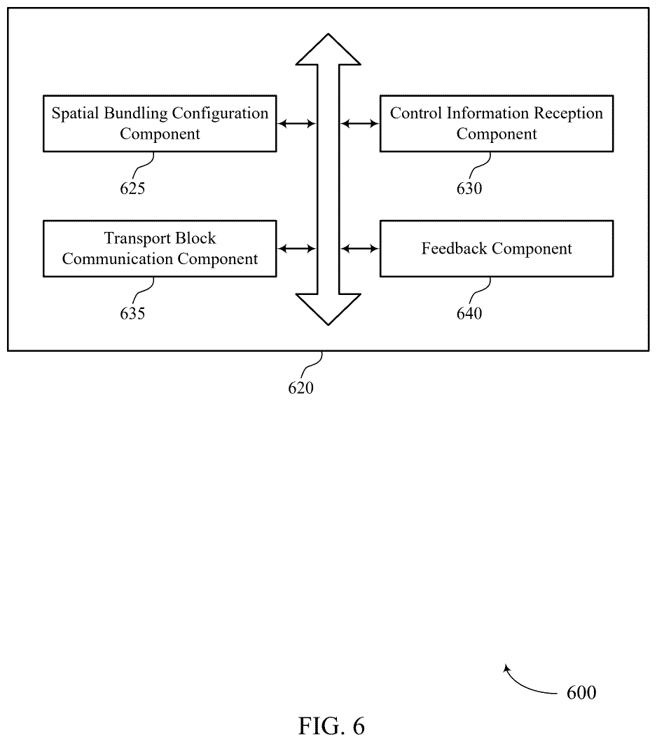

FIG. 6 shows a block diagram 600 of a communications manager 620 that supports multi-transport block scheduling in accordance with one or more aspects of the present disclosure. The communications manager 620 may be an example of aspects of a communications manager 420, a communications manager 520, or both, as described herein. The communications manager 620, or various components thereof, may be an example of means for performing various aspects of multi-transport block scheduling as described herein. For example, the communications manager 620 may include a spatial bundling configuration component 625, a control information reception component 630, a transport block communication component 635, a feedback component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The spatial bundling configuration component 625 is capable of, configured to, or operable to support a means for receiving control signaling that enables a spatial bundling feature for feedback. The control information reception component 630 is capable of, configured to, or operable to support a means for receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The transport block communication component 635 is capable of, configured to, or operable to support a means for communicating at least one transport block of the two or more transport blocks according to the downlink control information message and the single NDI field.

In some examples, the feedback component 640 is capable of, configured to, or operable to support a means for transmitting a single feedback message that indicates combined feedback for the two or more transport blocks in accordance with the spatial bundling feature being enabled and a value of the single NDI field.

In some examples, to support receiving the control signaling that enables the spatial bundling feature for feedback, the spatial bundling configuration component 625 is capable of, configured to, or operable to support a means for receiving, via the control signaling, one or more feedback configuration fields that enable the spatial bundling feature for feedback associated with a control channel and that enable feedback associated with a shared channel, where the downlink control information message includes the single NDI field associated with the two or more transport blocks based on the spatial bundling feature being enabled for both of the feedback associated with the control channel and the feedback associated with the shared channel.

In some examples, the transport block communication component 635 is capable of, configured to, or operable to support a means for communicating the one or more previous transport blocks that convey the previous data, where the one or more previous transport blocks include a single previous transport block that is associated with a previous NDI field, and where communicating the two or more transport blocks includes decoding the two or more transport blocks based on the previous NDI field including a different value than the single NDI field associated with the two or more transport blocks.

In some examples, the transport block communication component 635 is capable of, configured to, or operable to support a means for communicating the one or more previous transport blocks that convey the previous data, where the one or more previous transport blocks include a single previous transport block that is associated with a previous NDI field. In some examples, the transport block communication component 635 is capable of, configured to, or operable to support a means for determining that the two or more transport blocks correspond to new transmissions irrespective of a value of the single NDI field based on the one or more previous transport blocks including the single previous transport block.

In some examples, the transport block communication component 635 is capable of, configured to, or operable to support a means for communicating the one or more previous transport blocks that convey the previous data, where the one or more previous transport blocks include a single previous transport block that is associated with a previous NDI field. In some examples, the transport block communication component 635 is capable of, configured to, or operable to support a means for determining that the two or more transport blocks correspond to retransmissions of the previous data based on the single NDI field including a same value as the previous NDI field.

In some examples, to support receiving the downlink control information message, the control information reception component 630 is capable of, configured to, or operable to support a means for receiving, via the downlink control information message, a single RV field that indicates an RV for decoding the two or more transport blocks.

In some examples, the control information reception component 630 is capable of, configured to, or operable to support a means for receiving second control signaling that indicates one or more RV field configurations for one or more downlink control information formats, where the downlink control information message includes the single RV field based on an RV field configuration associated with the downlink control information message.

In some examples, to support receiving the downlink control information message, the control information reception component 630 is capable of, configured to, or operable to support a means for receiving, via the downlink control information message, a single RV field that indicates an RV for decoding the two or more transport blocks. In some examples, to support receiving the downlink control information message, the control information reception component 630 is capable of, configured to, or operable to support a means for receiving, via the downlink control information message, two or more MCS fields that correspond to the two or more transport blocks, where respective values of the two or more MCS fields indicate which one or more transport blocks, of the two or more transport blocks, are scheduled via the downlink control information message based on the downlink control information message including the single RV field.

In some examples, to support communicating the at least one transport block, the transport block communication component 635 is capable of, configured to, or operable to support a means for communicating one transport block of the two or more transport blocks, the one transport block being scheduled by the downlink control information message based on a rule for transport block scheduling in accordance with a value of the two or more MCS fields being associated with a same value for disabling respective transport blocks.

In some examples, to support communicating the at least one transport block, the transport block communication component 635 is capable of, configured to, or operable to support a means for communicating two transport blocks scheduled by the downlink control information message based on the respective values of each of the two or more MCS fields including a same value that is associated with disabling a transport block.

In some examples, to support receiving the downlink control information message, the control information reception component 630 is capable of, configured to, or operable to support a means for receiving, via the downlink control information message, a scheduling quantity field that indicates a quantity of transport blocks, of the two or more transport blocks, that are scheduled by the downlink control information message, where respective sizes of one or more fields of the downlink control information message, respective values of the one or more fields of the downlink control information message, or any combination thereof are based on the scheduling quantity field.

In some examples, the scheduling quantity field includes a bitmap. In some examples, each bit of the bitmap indicates whether a corresponding transport block of the two or more transport blocks is scheduled by the downlink control information message or is disabled.

In some examples, to support receiving the downlink control information message, the control information reception component 630 is capable of, configured to, or operable to support a means for receiving, via the downlink control information message, one or more zero-padding bits based on the quantity of transport blocks indicated by the scheduling quantity field.

In some examples, the downlink control information message includes a quantity of bits that is based on a maximum size from among one or more candidate sizes associated with one or more values of the scheduling quantity field.

In some examples, the single NDI field indicates whether the two or more transport blocks include the data that is the same as or different from previous data conveyed via the one or more previous transport blocks based on the one or more previous transport blocks and the two or more transport blocks being associated with a same hybrid automatic repeat request identifier.

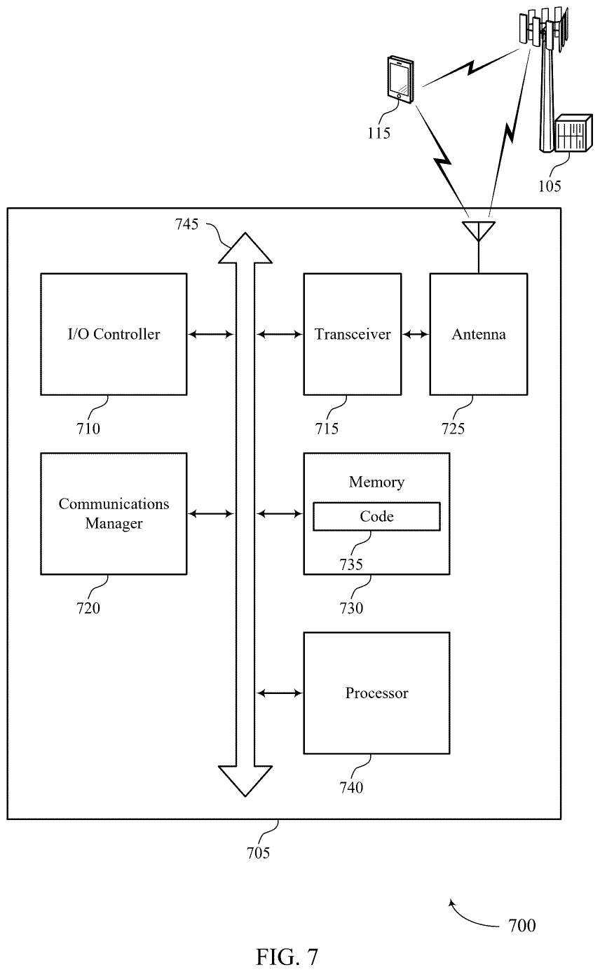

FIG. 7 shows a diagram of a system 700 including a device 705 that supports multi-transport block scheduling in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting multi-transport block scheduling). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving control signaling that enables a spatial bundling feature for feedback. The communications manager 720 is capable of, configured to, or operable to support a means for receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The communications manager 720 is capable of, configured to, or operable to support a means for communicating at least one transport block of the two or more transport blocks according to the downlink control information message and the single NDI field.

By including or configuring the communications manager 720 in accordance with examples as described herein, the device 705 may support techniques for reduced overhead, reduced power consumption, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of multi-transport block scheduling as described herein, or the at least one processor 740 and the at least one memory 730 may be otherwise configured to, individually or collectively, perform or support such operations.

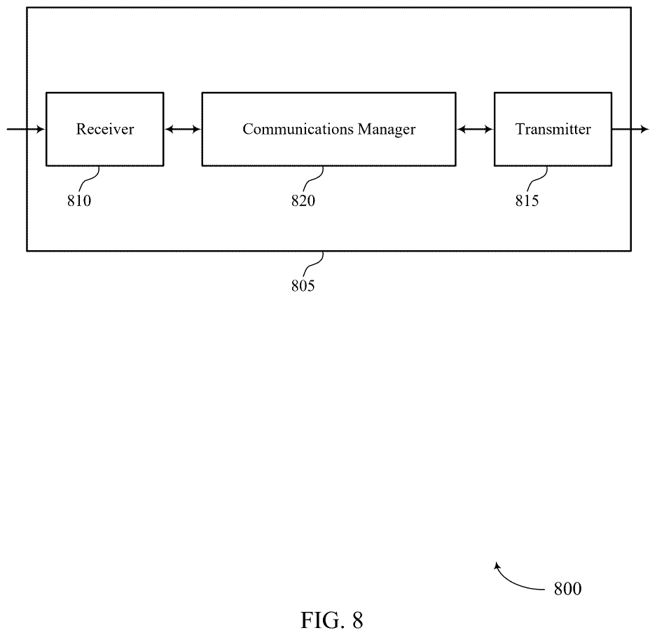

FIG. 8 shows a block diagram 800 of a device 805 that supports multi-transport block scheduling in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of multi-transport block scheduling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting control signaling that enables a spatial bundling feature for feedback. The communications manager 820 is capable of, configured to, or operable to support a means for transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The communications manager 820 is capable of, configured to, or operable to support a means for communicating at least one transport block of the two or more transport blocks according to the downlink control information message and the single NDI field.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and more efficient utilization of communication resources.

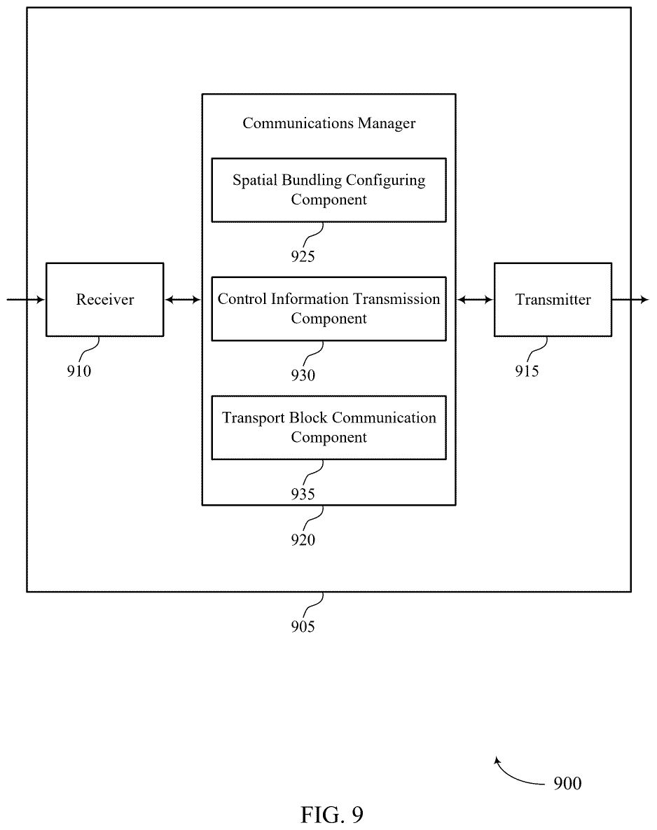

FIG. 9 shows a block diagram 900 of a device 905 that supports multi-transport block scheduling in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of multi-transport block scheduling as described herein. For example, the communications manager 920 may include a spatial bundling configuring component 925, a control information transmission component 930, a transport block communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The spatial bundling configuring component 925 is capable of, configured to, or operable to support a means for transmitting control signaling that enables a spatial bundling feature for feedback. The control information transmission component 930 is capable of, configured to, or operable to support a means for transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The transport block communication component 935 is capable of, configured to, or operable to support a means for communicating at least one transport block of the two or more transport blocks according to the downlink control information message and the single NDI field.

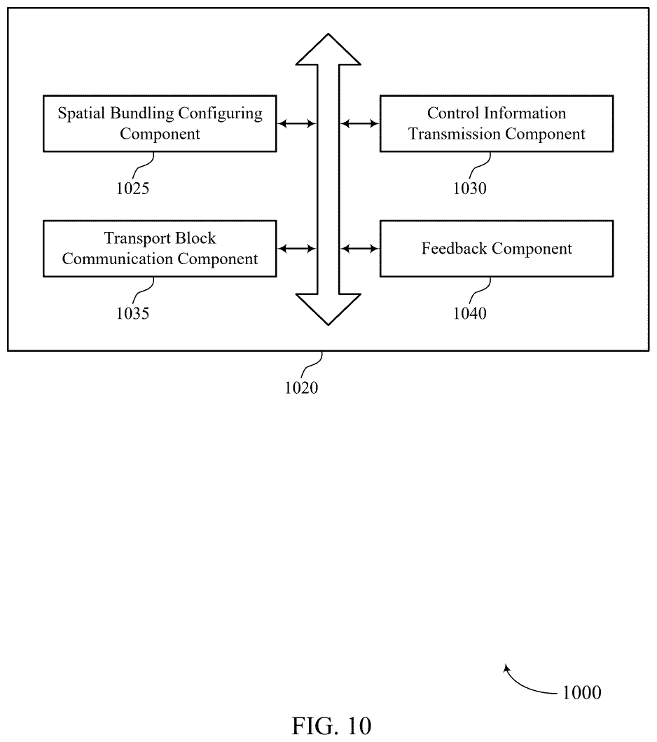

FIG. 10 shows a block diagram 1000 of a communications manager 1020 that supports multi-transport block scheduling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of multi-transport block scheduling as described herein. For example, the communications manager 1020 may include a spatial bundling configuring component 1025, a control information transmission component 1030, a transport block communication component 1035, a feedback component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The spatial bundling configuring component 1025 is capable of, configured to, or operable to support a means for transmitting control signaling that enables a spatial bundling feature for feedback. The control information transmission component 1030 is capable of, configured to, or operable to support a means for transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The transport block communication component 1035 is capable of, configured to, or operable to support a means for communicating at least one transport block of the two or more transport blocks according to the downlink control information message and the single NDI field.

In some examples, the feedback component 1040 is capable of, configured to, or operable to support a means for transmitting a single feedback message that indicates combined feedback for the two or more transport blocks in accordance with the spatial bundling feature being enabled and a value of the single NDI field.

In some examples, to support transmitting the control signaling that enables the spatial bundling feature for feedback, the spatial bundling configuring component 1025 is capable of, configured to, or operable to support a means for transmitting, via the control signaling, one or more feedback configuration fields that enable the spatial bundling feature for feedback associated with a control channel and that enable feedback associated with a shared channel, where the downlink control information message includes the single NDI field associated with the two or more transport blocks based on the spatial bundling feature being enabled for both of the feedback associated with the control channel and the feedback associated with the shared channel.

In some examples, to support transmitting the downlink control information message, the control information transmission component 1030 is capable of, configured to, or operable to support a means for transmitting, via the downlink control information message, a single RV field that indicates an RV for decoding the two or more transport blocks.

In some examples, the control information transmission component 1030 is capable of, configured to, or operable to support a means for transmitting second control signaling that indicates one or more RV field configurations for one or more downlink control information formats, where the downlink control information message includes the single RV field based on an RV field configuration associated with the downlink control information message.

In some examples, to support transmitting the downlink control information message, the control information transmission component 1030 is capable of, configured to, or operable to support a means for transmitting, via the downlink control information message, a single RV field that indicates an RV for decoding the two or more transport blocks. In some examples, to support transmitting the downlink control information message, the control information transmission component 1030 is capable of, configured to, or operable to support a means for transmitting, via the downlink control information message, two or more MCS fields that correspond to the two or more transport blocks, where respective values of the two or more MCS fields indicate which one or more transport blocks, of the two or more transport blocks, are scheduled via the downlink control information message based on the downlink control information message including the single RV field.

In some examples, to support communicating the at least one transport block, the transport block communication component 1035 is capable of, configured to, or operable to support a means for communicating one transport block of the two or more transport blocks, the one transport block being scheduled by the downlink control information message based on a rule for transport block scheduling in accordance with a value of the two or more MCS fields being associated with a same value for disabling respective transport blocks.

In some examples, to support communicating the at least one transport block, the transport block communication component 1035 is capable of, configured to, or operable to support a means for communicating two transport blocks scheduled by the downlink control information message based on the respective values of each of the two or more MCS fields including a same value that is associated with disabling a transport block.

In some examples, to support transmitting the downlink control information message, the control information transmission component 1030 is capable of, configured to, or operable to support a means for transmitting, via the downlink control information message, a scheduling quantity field that indicates a quantity of transport blocks, of the two or more transport blocks, that are scheduled by the downlink control information message, where respective sizes of one or more fields of the downlink control information message, respective values of the one or more fields of the downlink control information message, or any combination thereof are based on the scheduling quantity field.

In some examples, the scheduling quantity field includes a bitmap. In some examples, each bit of the bitmap indicates whether a corresponding transport block of the two or more transport blocks is scheduled by the downlink control information message or is disabled.

In some examples, to support transmitting the downlink control information message, the control information transmission component 1030 is capable of, configured to, or operable to support a means for transmitting, via the downlink control information message, one or more zero-padding bits based on the quantity of transport blocks indicated by the scheduling quantity field.

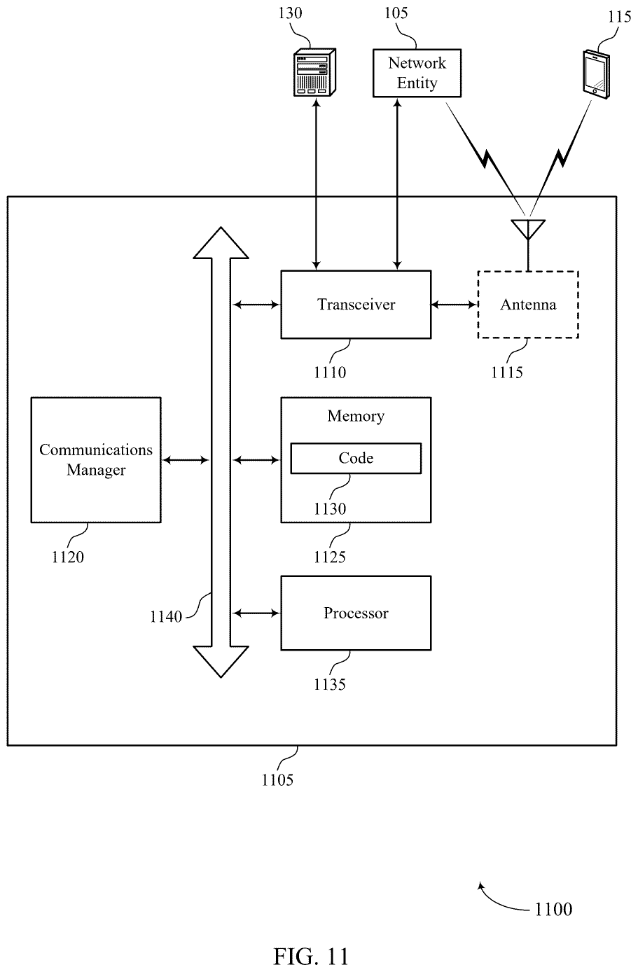

FIG. 11 shows a diagram of a system 1100 including a device 1105 that supports multi-transport block scheduling in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting multi-transport block scheduling). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting control signaling that enables a spatial bundling feature for feedback. The communications manager 1120 is capable of, configured to, or operable to support a means for transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The communications manager 1120 is capable of, configured to, or operable to support a means for communicating at least one transport block of the two or more transport blocks according to the downlink control information message and the single NDI field.

By including or configuring the communications manager 1120 in accordance with examples as described herein, the device 1105 may support techniques for reduced overhead, improved user experience related to reduced processing, and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of multi-transport block scheduling as described herein, or the at least one processor 1135 and the at least one memory 1125 may be otherwise configured to, individually or collectively, perform or support such operations.

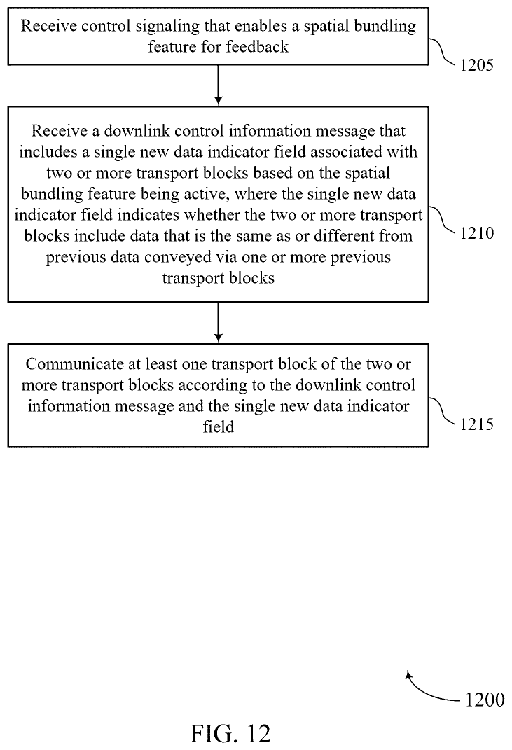

FIG. 12 shows a flowchart illustrating a method 1200 that supports multi-transport block scheduling in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling that enables a spatial bundling feature for feedback. The operations of 1205 may be performed in accordance with examples as disclosed herein. In some examples, aspects of the operations of 1205 may be performed by a spatial bundling configuration component 625 as described with reference to FIG. 6.

At 1210, the method may include receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The operations of 1210 may be performed in accordance with examples as disclosed herein. In some examples, aspects of the operations of 1210 may be performed by a control information reception component 630 as described with reference to FIG. 6.

At 1215, the method may include communicating at least one transport block of the two or more transport blocks according to the downlink control information message and the single NDI field. The operations of 1215 may be performed in accordance with examples as disclosed herein. In some examples, aspects of the operations of 1215 may be performed by a transport block communication component 635 as described with reference to FIG. 6.

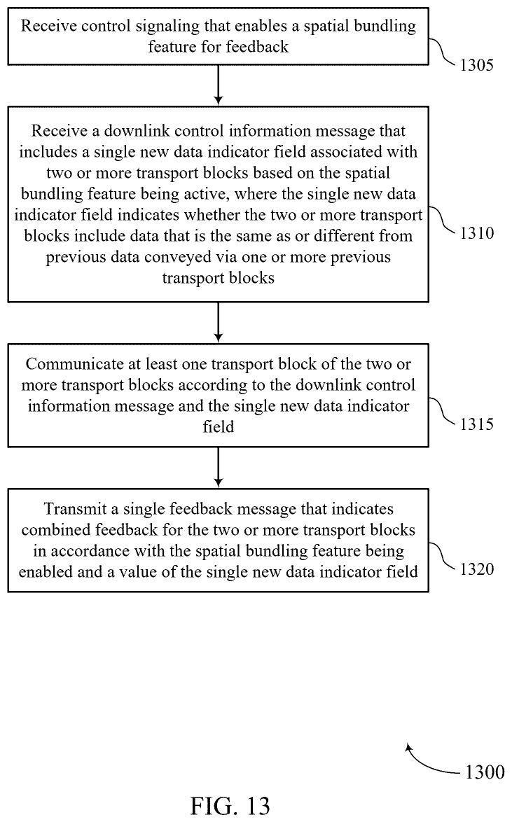

FIG. 13 shows a flowchart illustrating a method 1300 that supports multi-transport block scheduling in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that enables a spatial bundling feature for feedback. The operations of 1305 may be performed in accordance with examples as disclosed herein. In some examples, aspects of the operations of 1305 may be performed by a spatial bundling configuration component 625 as described with reference to FIG. 6.

At 1310, the method may include receiving a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The operations of 1310 may be performed in accordance with examples as disclosed herein. In some examples, aspects of the operations of 1310 may be performed by a control information reception component 630 as described with reference to FIG. 6.

At 1315, the method may include communicating at least one transport block of the two or more transport blocks according to the downlink control information message and the single NDI field. The operations of 1315 may be performed in accordance with examples as disclosed herein. In some examples, aspects of the operations of 1315 may be performed by a transport block communication component 635 as described with reference to FIG. 6.

At 1320, the method may include transmitting a single feedback message that indicates combined feedback for the two or more transport blocks in accordance with the spatial bundling feature being enabled and a value of the single NDI field. The operations of 1320 may be performed in accordance with examples as disclosed herein. In some examples, aspects of the operations of 1320 may be performed by a feedback component 640 as described with reference to FIG. 6.

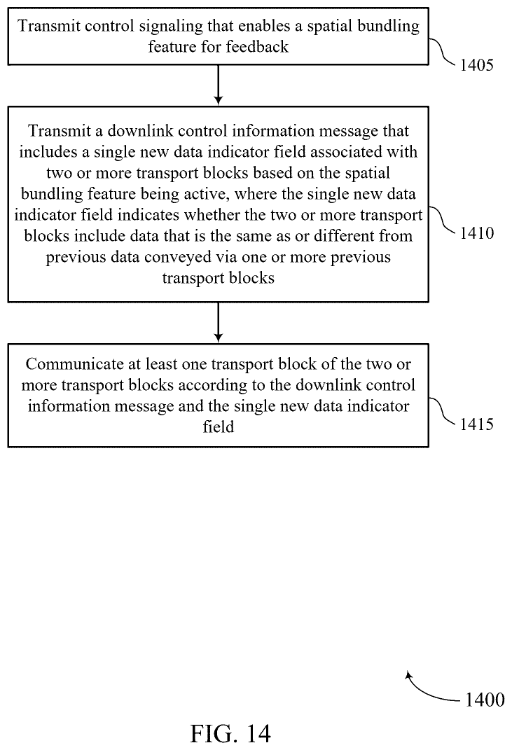

FIG. 14 shows a flowchart illustrating a method 1400 that supports multi-transport block scheduling in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting control signaling that enables a spatial bundling feature for feedback. The operations of 1405 may be performed in accordance with examples as disclosed herein. In some examples, aspects of the operations of 1405 may be performed by a spatial bundling configuring component 1025 as described with reference to FIG. 10.

At 1410, the method may include transmitting a downlink control information message that includes a single NDI field associated with two or more transport blocks based on the spatial bundling feature being active, where the single NDI field indicates whether the two or more transport blocks include data that is the same as or different from previous data conveyed via one or more previous transport blocks. The operations of 1410 may be performed in accordance with examples as disclosed herein. In some examples, aspects of the operations of 1410 may be performed by a control information transmission component 1030 as described with reference to FIG. 10.

At 1415, the method may include communicating at least one transport block of the two or more transport blocks according to the downlink control information message and the single NDI field. The operations of 1415 may be performed in accordance with examples as disclosed herein. In some examples, aspects of the operations of 1415 may be performed by a transport block communication component 1035 as described with reference to FIG. 10.

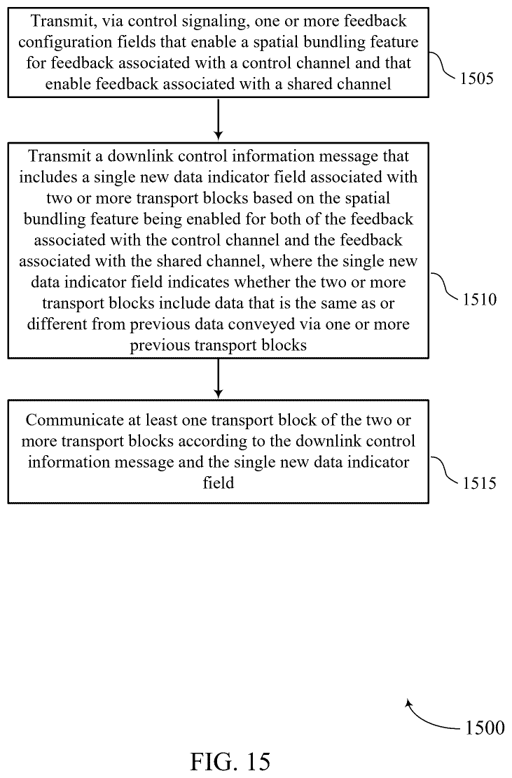

FIG. 15 shows a flowchart illustrating a method 1500 that supports multi-transport block scheduling in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, via control signaling, one or more feedback configuration fields that enable a spatial bundling feature for feedback associated with a control channel and that enable feedback associated with a shared channel. The operations of 1505 may be performed in accordance with examples as disclosed herein. In some examples, aspects of the operations of 1505 may be performed by a spatial bundling configuring component 1025 as described with reference to FIG. 10.

At 1510, the method may include transmitting a downlink control information message that includes a single NDI field associated with two or more transport blocks based on the spatial bundling feature being enabled for both of the feedback associated with the control channel and the feedback associated with the shared channel, where the single NDI field indicates whether the two or more transport blocks include data that is the same as or different from previous data conveyed via one or more previous transport blocks. The operations of 1510 may be performed in accordance with examples as disclosed herein. In some examples, aspects of the operations of 1510 may be performed by a control information transmission component 1030 as described with reference to FIG. 10.

At 1515, the method may include communicating at least one transport block of the two or more transport blocks according to the downlink control information message and the single NDI field. The operations of 1515 may be performed in accordance with examples as disclosed herein. In some examples, aspects of the operations of 1515 may be performed by a transport block communication component 1035 as described with reference to FIG. 10.

The following provides an overview of aspects of the present disclosure:
Aspect 1: A method for wireless communications at a UE, comprising: receiving control signaling that enables a spatial bundling feature for feedback; receiving a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and communicating at least one transport block of the two or more transport blocks according to the downlink control information message and the single new data indicator field.
Aspect 2: The method of aspect 1, further comprising: transmitting a single feedback message that indicates combined feedback for the two or more transport blocks in accordance with the spatial bundling feature being enabled and a value of the single new data indicator field.
Aspect 3: The method of any of aspects 1 through 2, wherein receiving the control signaling that enables the spatial bundling feature for feedback comprises: receiving, via the control signaling, one or more feedback configuration fields that enable the spatial bundling feature for feedback associated with a control channel and that enable feedback associated with a shared channel, wherein the downlink control information message comprises the single new data indicator field associated with the two or more transport blocks based at least in part on the spatial bundling feature being enabled for both of the feedback associated with the control channel and the feedback associated with the shared channel.
Aspect 4: The method of any of aspects 1 through 3, further comprising: communicating the one or more previous transport blocks that convey the previous data, wherein the one or more previous transport blocks comprise a single previous transport block that is associated with a previous new data indicator field, and wherein communicating the two or more transport blocks comprises decoding the two or more transport blocks based at least in part on the previous new data indicator field comprising a different value than the single new data indicator field associated with the two or more transport blocks.
Aspect 5: The method of any of aspects 1 through 4, further comprising: communicating the one or more previous transport blocks that convey the previous data, wherein the one or more previous transport blocks comprise a single previous transport block that is associated with a previous new data indicator field; and determining that the two or more transport blocks correspond to new transmissions irrespective of a value of the single new data indicator field based at least in part on the one or more previous transport blocks comprising the single previous transport block.
Aspect 6: The method of any of aspects 1 through 5, further comprising: communicating the one or more previous transport blocks that convey the previous data, wherein the one or more previous transport blocks comprise a single previous transport block that is associated with a previous new data indicator field; and determining that the two or more transport blocks correspond to retransmissions of the previous data based at least in part on the single new data indicator field comprising a same value as the previous new data indicator field.
Aspect 7: The method of any of aspects 1 through 6, wherein receiving the downlink control information message comprises: receiving, via the downlink control information message, a single redundancy version field that indicates a redundancy version for decoding the two or more transport blocks.
Aspect 8: The method of aspect 7, further comprising: receiving second control signaling that indicates one or more redundancy version field configurations for one or more downlink control information formats, wherein the downlink control information message comprises the single redundancy version field based at least in part on a redundancy version field configuration associated with the downlink control information message.
Aspect 9: The method of any of aspects 1 through 8, wherein receiving the downlink control information message comprises: receiving, via the downlink control information message, a single redundancy version field that indicates a redundancy version for decoding the two or more transport blocks; and receiving, via the downlink control information message, two or more modulation and coding scheme fields that correspond to the two or more transport blocks, wherein respective values of the two or more modulation and coding scheme fields indicate which one or more transport blocks, of the two or more transport blocks, are scheduled via the downlink control information message based at least in part on the downlink control information message comprising the single redundancy version field.
Aspect 10: The method of aspect 9, wherein communicating the at least one transport block comprises: communicating one transport block of the two or more transport blocks, the one transport block being scheduled by the downlink control information message based at least in part on a rule for transport block scheduling in accordance with a value of the two or more modulation and coding scheme fields being associated with a same value for disabling respective transport blocks.
Aspect 11: The method of any of aspects 9 through 10, wherein communicating the at least one transport block comprises: communicating two transport blocks scheduled by the downlink control information message based at least in part on the respective values of each of the two or more modulation and coding scheme fields comprising a same value that is associated with disabling a transport block.
Aspect 12: The method of any of aspects 1 through 11, wherein receiving the downlink control information message comprises: receiving, via the downlink control information message, a scheduling quantity field that indicates a quantity of transport blocks, of the two or more transport blocks, that are scheduled by the downlink control information message, wherein respective sizes of one or more fields of the downlink control information message, respective values of the one or more fields of the downlink control information message, or any combination thereof are based at least in part on the scheduling quantity field.
Aspect 13: The method of aspect 12, wherein the scheduling quantity field comprises a bitmap, and each bit of the bitmap indicates whether a corresponding transport block of the two or more transport blocks is scheduled by the downlink control information message or is disabled.
Aspect 14: The method of any of aspects 12 through 13, wherein receiving the downlink control information message comprises: receiving, via the downlink control information message, one or more zero-padding bits based at least in part on the quantity of transport blocks indicated by the scheduling quantity field.
Aspect 15: The method of any of aspects 12 through 14, wherein the downlink control information message comprises a quantity of fields that is based at least in part on a maximum size from among one or more candidate sizes associated with one or more values of the scheduling quantity field.
Aspect 16: The method of any of aspects 1 through 15, wherein the single new data indicator field indicates whether the two or more transport blocks comprise the data that is the same as or different from previous data conveyed via the one or more previous transport blocks based at least in part on the one or more previous transport blocks and the two or more transport blocks being associated with a same hybrid automatic repeat request identifier.
Aspect 17: A method for wireless communications at a network entity, comprising: transmitting control signaling that enables a spatial bundling feature for feedback; transmitting a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and communicating at least one transport block of the two or more transport blocks according to the downlink control information message and the single new data indicator field.
Aspect 18: The method of aspect 17, further comprising: transmitting a single feedback message that indicates combined feedback for the two or more transport blocks in accordance with the spatial bundling feature being enabled and a value of the single new data indicator field.
Aspect 19: The method of any of aspects 17 through 18, wherein transmitting the control signaling that enables the spatial bundling feature for feedback comprises: transmitting, via the control signaling, one or more feedback configuration fields that enable the spatial bundling feature for feedback associated with a control channel and that enable feedback associated with a shared channel, wherein the downlink control information message comprises the single new data indicator field associated with the two or more transport blocks based at least in part on the spatial bundling feature being enabled for both of the feedback associated with the control channel and the feedback associated with the shared channel.
Aspect 20: The method of any of aspects 17 through 19, wherein transmitting the downlink control information message comprises: transmitting, via the downlink control information message, a single redundancy version field that indicates a redundancy version for decoding the two or more transport blocks.
Aspect 21: The method of aspect 20, further comprising: transmitting second control signaling that indicates one or more redundancy version field configurations for one or more downlink control information formats, wherein the downlink control information message comprises the single redundancy version field based at least in part on a redundancy version field configuration associated with the downlink control information message.
Aspect 22: The method of any of aspects 17 through 21, wherein transmitting the downlink control information message comprises: transmitting, via the downlink control information message, a single redundancy version field that indicates a redundancy version for decoding the two or more transport blocks; and transmitting, via the downlink control information message, two or more modulation and coding scheme fields that correspond to the two or more transport blocks, wherein respective values of the two or more modulation and coding scheme fields indicate which one or more transport blocks, of the two or more transport blocks, are scheduled via the downlink control information message based at least in part on the downlink control information message comprising the single redundancy version field.
Aspect 23: The method of aspect 22, wherein communicating the at least one transport block comprises: communicating one transport block of the two or more transport blocks, the one transport block being scheduled by the downlink control information message based at least in part on a rule for transport block scheduling in accordance with a value of the two or more modulation and coding scheme fields being associated with a same value for disabling respective transport blocks.
Aspect 24: The method of any of aspects 22 through 23, wherein communicating the at least one transport block comprises: communicating two transport blocks scheduled by the downlink control information message based at least in part on the respective values of each of the two or more modulation and coding scheme fields comprising a same value that is associated with disabling a transport block.
Aspect 25: The method of any of aspects 17 through 24, wherein transmitting the downlink control information message comprises: transmitting, via the downlink control information message, a scheduling quantity field that indicates a quantity of transport blocks, of the two or more transport blocks, that are scheduled by the downlink control information message, wherein respective sizes of one or more fields of the downlink control information message, respective values of the one or more fields of the downlink control information message, or any combination thereof are based at least in part on the scheduling quantity field.
Aspect 26: The method of aspect 25, wherein the scheduling quantity field comprises a bitmap, and each bit of the bitmap indicates whether a corresponding transport block of the two or more transport blocks is scheduled by the downlink control information message or is disabled.
Aspect 27: The method of any of aspects 25 through 26, wherein transmitting the downlink control information message comprises: transmitting, via the downlink control information message, one or more zero-padding bits based at least in part on the quantity of transport blocks indicated by the scheduling quantity field.
Aspect 28: A UE for wireless communications, comprising one or more memories storing processor-executable code, and one or more processors coupled with the one or more memories and individually or collectively operable to execute the code to cause the UE to perform a method of any of aspects 1 through 16.
Aspect 29: A UE for wireless communications, comprising at least one means for performing a method of any of aspects 1 through 16.
Aspect 30: A non-transitory computer-readable medium storing code for wireless communications, the code comprising instructions executable by one or more processors to perform a method of any of aspects 1 through 16.
Aspect 31: A network entity for wireless communications, comprising one or more memories storing processor-executable code, and one or more processors coupled with the one or more memories and individually or collectively operable to execute the code to cause the network entity to perform a method of any of aspects 17 through 27.
Aspect 32: A network entity for wireless communications, comprising at least one means for performing a method of any of aspects 17 through 27.
Aspect 33: A non-transitory computer-readable medium storing code for wireless communications, the code comprising instructions executable by one or more processors to perform a method of any of aspects 17 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that enables a spatial bundling feature for feedback;
receive a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and
communicate at least one transport block of the two or more transport blocks according to the downlink control information message and the single new data indicator field.

2. The UE of claim 1, wherein the one or more processors are individually or collectively further operable to execute the code to cause the UE to:
transmit a single feedback message that indicates combined feedback for the two or more transport blocks in accordance with the spatial bundling feature being enabled and a value of the single new data indicator field.

3. The UE of claim 1, wherein, to receive the control signaling that enables the spatial bundling feature for feedback, the one or more processors are individually or collectively operable to execute the code to cause the UE to:
receive, via the control signaling, one or more feedback configuration fields that enable the spatial bundling feature for feedback associated with a control channel and that enable feedback associated with a shared channel, wherein the downlink control information message comprises the single new data indicator field associated with the two or more transport blocks based at least in part on the spatial bundling feature being enabled for both of the feedback associated with the control channel and the feedback associated with the shared channel.

4. The UE of claim 1, wherein the one or more processors are individually or collectively further operable to execute the code to cause the UE to:
communicate the one or more previous transport blocks that convey the previous data, wherein the one or more previous transport blocks comprise a single previous transport block that is associated with a previous new data indicator field, and wherein, to communicate the two or more transport blocks, the one or more processors are individually or collectively further operable to execute the code to cause the UE to decode the two or more transport blocks based at least in part on the previous new data indicator field comprising a different value than the single new data indicator field associated with the two or more transport blocks.

5. The UE of claim 1, wherein the one or more processors are individually or collectively further operable to execute the code to cause the UE to:
communicate the one or more previous transport blocks that convey the previous data, wherein the one or more previous transport blocks comprise a single previous transport block that is associated with a previous new data indicator field; and
determine that the two or more transport blocks correspond to new transmissions irrespective of a value of the single new data indicator field based at least in part on the one or more previous transport blocks comprising the single previous transport block.

6. The UE of claim 1, wherein the one or more processors are individually or collectively further operable to execute the code to cause the UE to:
communicate the one or more previous transport blocks that convey the previous data, wherein the one or more previous transport blocks comprise a single previous transport block that is associated with a previous new data indicator field; and
determine that the two or more transport blocks correspond to retransmissions of the previous data based at least in part on the single new data indicator field comprising a same value as the previous new data indicator field.

7. The UE of claim 1, wherein, to receive the downlink control information message, the one or more processors are individually or collectively operable to execute the code to cause the UE to:
receive, via the downlink control information message, a single redundancy version field that indicates a redundancy version for decoding the two or more transport blocks.

8. The UE of claim 7, wherein the one or more processors are individually or collectively further operable to execute the code to cause the UE to:
receive second control signaling that indicates one or more redundancy version field configurations for one or more downlink control information formats, wherein the downlink control information message comprises the single redundancy version field based at least in part on a redundancy version field configuration associated with the downlink control information message.

9. The UE of claim 1, wherein, to receive the downlink control information message, the one or more processors are individually or collectively operable to execute the code to cause the UE to:
receive, via the downlink control information message, a single redundancy version field that indicates a redundancy version for decoding the two or more transport blocks; and
receive, via the downlink control information message, two or more modulation and coding scheme fields that correspond to the two or more transport blocks, wherein respective values of the two or more modulation and coding scheme fields indicate which one or more transport blocks, of the two or more transport blocks, are scheduled via the downlink control information message based at least in part on the downlink control information message comprising the single redundancy version field.

10. The UE of claim 9, wherein, to communicate the at least one transport block, the one or more processors are individually or collectively operable to execute the code to cause the UE to:
communicate one transport block of the two or more transport blocks, the one transport block being scheduled by the downlink control information message based at least in part on a rule for transport block scheduling in accordance with a value of the two or more modulation and coding scheme fields being associated with a same value for disabling respective transport blocks.

11. The UE of claim 9, wherein, to communicate the at least one transport block, the one or more processors are individually or collectively operable to execute the code to cause the UE to:
communicate two transport blocks scheduled by the downlink control information message based at least in part on the respective values of each of the two or more modulation and coding scheme fields comprising a same value that is associated with disabling a transport block.

12. The UE of claim 1, wherein, to receive the downlink control information message, the one or more processors are individually or collectively operable to execute the code to cause the UE to:
receive, via the downlink control information message, a scheduling quantity field that indicates a quantity of transport blocks, of the two or more transport blocks, that are scheduled by the downlink control information message, wherein respective sizes of one or more fields of the downlink control information message, respective values of the one or more fields of the downlink control information message, or any combination thereof are based at least in part on the scheduling quantity field.

13. The UE of claim 12, wherein:
the scheduling quantity field comprises a bitmap, and
each bit of the bitmap indicates whether a corresponding transport block of the two or more transport blocks is scheduled by the downlink control information message or is disabled.

14. The UE of claim 12, wherein, to receive the downlink control information message, the one or more processors are individually or collectively operable to execute the code to cause the UE to:
receive, via the downlink control information message, one or more zero-padding bits based at least in part on the quantity of transport blocks indicated by the scheduling quantity field.

15. The UE of claim 12, wherein the downlink control information message comprises a quantity of bits that is based at least in part on a maximum size from among one or more candidate sizes associated with one or more values of the scheduling quantity field.

16. The UE of claim 1, wherein the single new data indicator field indicates whether the two or more transport blocks comprise the data that is the same as or different from previous data conveyed via the one or more previous transport blocks based at least in part on the one or more previous transport blocks and the two or more transport blocks being associated with a same hybrid automatic repeat request identifier.

17. A network entity, comprising:
one or more memories storing processor-executable code; and
one or more processors coupled with the one or more memories and individually or collectively operable to execute the code to cause the network entity to:
transmit control signaling that enables a spatial bundling feature for feedback;
transmit a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and
communicate at least one transport block of the two or more transport blocks according to the downlink control information message and the single new data indicator field.

18. The network entity of claim 17, wherein the one or more processors are individually or collectively further operable to execute the code to cause the network entity to:
transmit a single feedback message that indicates combined feedback for the two or more transport blocks in accordance with the spatial bundling feature being enabled and a value of the single new data indicator field.

19. The network entity of claim 17, wherein, to transmit the control signaling that enables the spatial bundling feature for feedback, the one or more processors are individually or collectively operable to execute the code to cause the network entity to:
transmit, via the control signaling, one or more feedback configuration fields that enable the spatial bundling feature for feedback associated with a control channel and that enable feedback associated with a shared channel, wherein the downlink control information message comprises the single new data indicator field associated with the two or more transport blocks based at least in part on the spatial bundling feature being enabled for both of the feedback associated with the control channel and the feedback associated with the shared channel.

20. The network entity of claim 17, wherein, to transmit the downlink control information message, the one or more processors are individually or collectively operable to execute the code to cause the network entity to:
transmit, via the downlink control information message, a single redundancy version field that indicates a redundancy version for decoding the two or more transport blocks.

21. The network entity of claim 20, wherein the one or more processors are individually or collectively further operable to execute the code to cause the network entity to:
transmit second control signaling that indicates one or more redundancy version field configurations for one or more downlink control information formats, wherein the downlink control information message comprises the single redundancy version field based at least in part on a redundancy version field configuration associated with the downlink control information message.

22. The network entity of claim 17, wherein, to transmit the downlink control information message, the one or more processors are individually or collectively operable to execute the code to cause the network entity to:
transmit, via the downlink control information message, a single redundancy version field that indicates a redundancy version for decoding the two or more transport blocks; and
transmit, via the downlink control information message, two or more modulation and coding scheme fields that correspond to the two or more transport blocks, wherein respective values of the two or more modulation and coding scheme fields indicate which one or more transport blocks, of the two or more transport blocks, are scheduled via the downlink control information message based at least in part on the downlink control information message comprising the single redundancy version field.

23. The network entity of claim 22, wherein, to communicate the at least one transport block, the one or more processors are individually or collectively operable to execute the code to cause the network entity to:
communicate one transport block of the two or more transport blocks, the one transport block being scheduled by the downlink control information message based at least in part on a rule for transport block scheduling in accordance with a value of the two or more modulation and coding scheme fields being associated with a same value for disabling respective transport blocks.

24. The network entity of claim 22, wherein, to communicate the at least one transport block, the one or more processors are individually or collectively operable to execute the code to cause the network entity to:
communicate two transport blocks scheduled by the downlink control information message based at least in part on the respective values of each of the two or more modulation and coding scheme fields comprising a same value that is associated with disabling a transport block.

25. The network entity of claim 17, wherein, to transmit the downlink control information message, the one or more processors are individually or collectively operable to execute the code to cause the network entity to:
transmit, via the downlink control information message, a scheduling quantity field that indicates a quantity of transport blocks, of the two or more transport blocks, that are scheduled by the downlink control information message, wherein respective sizes of one or more fields of the downlink control information message, respective values of the one or more fields of the downlink control information message, or any combination thereof are based at least in part on the scheduling quantity field.

26. The network entity of claim 25, wherein:
the scheduling quantity field comprises a bitmap, and
each bit of the bitmap indicates whether a corresponding transport block of the two or more transport blocks is scheduled by the downlink control information message or is disabled.

27. The network entity of claim 25, wherein, to transmit the downlink control information message, the one or more processors are individually or collectively operable to execute the code to cause the network entity to:
transmit, via the downlink control information message, one or more zero-padding bits based at least in part on the quantity of transport blocks indicated by the scheduling quantity field.

28. A method for wireless communications at a user equipment (UE), comprising:
receiving control signaling that enables a spatial bundling feature for feedback;
receiving a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and
communicating at least one transport block of the two or more transport blocks according to the downlink control information message and the single new data indicator field.

29. The method of claim 28, further comprising:
transmitting a single feedback message that indicates combined feedback for the two or more transport blocks in accordance with the spatial bundling feature being enabled and a value of the single new data indicator field.

30. A method for wireless communications at a network entity, comprising:
transmitting control signaling that enables a spatial bundling feature for feedback;
transmitting a downlink control information message that comprises a single new data indicator field associated with two or more transport blocks based at least in part on the spatial bundling feature being active, wherein the single new data indicator field indicates whether the two or more transport blocks comprise data that is the same as or different from previous data conveyed via one or more previous transport blocks; and
communicating at least one transport block of the two or more transport blocks according to the downlink control information message and the single new data indicator field.
